(19) United States
(12) Patent Application Publication
(10) Pub. No.: US 2011/0096312 A1
(43) Pub. Date: Apr. 28, 2011

(54) EXPOSURE APPARATUS AND DEVICE FABRICATING METHOD

(75) Inventor: Hiromitsu YOSHIMOTO, Saitama-shi (JP)

(73) Assignee: NIKON CORPORATION, Tokyo (JP)

(21) Appl. No.: 12/887,754

(22) Filed: Sep. 22, 2010

Related U.S. Application Data
(60) Provisional application No. 61/272,469, filed on Sep. 28, 2009.

(51) Int. Cl. G03B 27/52

(52) U.S. Cl. 355/55

(57) ABSTRACT

An exposure apparatus includes: a first moving body, which comprises a guide member that extends in a first direction, that moves in a second direction, which is substantially orthogonal to the first direction; two second moving bodies, which are provided such that they are capable of moving in the first direction along the guide members, that move in the second direction together with the guide member by the movement of the first moving body; and a holding member, which is detachably supported by the two second moving bodies and is capable of holding the object and moving with respect to the two second moving bodies. The second moving bodies include a first drive part and a second drive part that are independently controllable.

### CROSS-REFERENCE TO RELATED APPLICATION

This application is a non-provisional application claiming priority to and the benefit of U.S. provisional application No. 61/272,469, filed Sep. 28, 2009. The entire contents of which are incorporated herein by reference.

### BACKGROUND

The present invention relates to an exposure apparatus and a device fabricating method.

Conventionally, lithographic processes that fabricate electronic devices (i.e., microdevices), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

Wafers that undergo exposure and substrates like glass plates that are used in various exposure apparatuses have been increasing in size with time (e.g., wafers have increased in size every 10 years). Presently, the mainstream wafer has a diameter of 300 mm, and the era of a wafer with a diameter of 450 mm is nearing. When the industry transitions to the 450 mm wafer, the number of dies (i.e., chips) yielded by one wafer will increase to more than double that of the current 300 mm wafer, which will help reduce costs. In addition, it is anticipated that the effective utilization of energy, water, and other resources will further reduce the total resources consumed per chip.

However, as wafers increase in size, wafer stages, which move while holding the wafer, also increase in both size and weight. Particularly in the case of a scanner, wherein an exposure (i.e., the transfer of a reticle pattern) is performed during the synchronous movement of a reticle stage and a wafer stage as disclosed in, for example, U.S. Pat. No. 5,646,413, increasing the weight of the wafer stage tends to degrade the position control performance of the wafer stage, increase the size of the wafer stage, and increase the footprint of the apparatus. Consequently, it is preferable to make members that move while holding the wafer thin and lightweight. However, because a wafer's thickness does not increase in proportion to its size, the strength of a 450 mm wafer is markedly less than that of a 300 mm wafer; therefore, making the movable member thinner risks deforming the movable member owing its self weight as well as the weight of the wafer and, as a result, deforming the wafer held by the movable member, thereby degrading the accuracy with which the pattern is transferred to the wafer.

Accordingly, it is expected that new systems that are capable of handling 450 mm wafers will appear.

### SUMMARY

An exposure apparatus according to a first aspect of the present invention is an exposure apparatus that forms a pattern on an object by radiating an energy beam and comprises: a first moving body, which comprises guide members that extend in a first direction, that moves in a second direction, which is substantially orthogonal to the first direction; two second moving bodies, which are provided such that they are capable of moving in the first direction along the guide members, that move in the second direction together with the guide members by the movement of the first moving body; and a holding member, which is detachably supported by the two second moving bodies and is capable of holding the object and moving with respect to the two second moving bodies; wherein, the second moving bodies comprise: a first drive part, which is provided to one of the two second moving bodies, that exerts upon one end part of the holding member driving forces in a direction parallel to the first direction, a direction parallel to the second direction, a direction orthogonal to a two dimensional plane that includes the first direction and the second direction, and a rotational direction around an axis parallel to the first direction; and a second drive part, which is provided to the other of the two second moving bodies, that exerts upon an other end part of the holding member, which is on a side opposite that of the one end part in the first direction, a driving force in a direction parallel to the first direction, a direction parallel to the second direction, a direction orthogonal to the two dimensional plane that includes the first direction and the second direction, and a rotational direction around an axis parallel to the first direction; and the first drive part and the second drive part are independently controllable.

A device fabricating method according to a second aspect of the present invention is a device fabricating method that comprises the steps of: exposing a substrate, which serves as the object, using an exposure apparatus according to the first aspect of the present invention; and developing the exposed substrate.

According to some aspects of the present invention, deformation owing to, for example, the self weight of a moving body that holds an object can be prevented.

### BRIEF DESCRIPTION OF THE DRAWINGS

FIG. 1 schematically shows the configuration of an exposure apparatus of one embodiment.

FIG. 2 is an external oblique view of a stage apparatus.

FIG. 3 is a partial exploded oblique view of the stage apparatus.

FIG. 4 is a plan view that shows the wafer stage.

FIG. 5 is a front view of a wafer stage shown in isolation from an X coarse motion stage.

FIG. 6 is a block diagram that shows the configuration of a control system of the exposure apparatus shown in FIG. 1.

FIG. 7 is a plan view that shows the arrangement of magnet units and a coil unit that constitute a fine motion stage drive system.

FIG. 8A is a side view, viewed from the −Y direction, that shows the arrangement of the magnet units and the coil unit that constitute the fine motion stage drive system.

FIG. 8B is a side view, viewed from the +X direction, that shows the arrangement of the magnet units and the coil unit that constitute the fine motion stage drive system.

FIG. 9A is for explaining the drive principle by which a fine motion stage is driven in the Y axial directions.

FIG. 9B is for explaining the drive principle by which the fine motion stage is driven in the Z axial directions.

FIG. 9C is for explaining the drive principle by which the fine motion stage is driven in the X axial directions.

FIG. 10A is a view for explaining the operation performed when a fine motion stage is rotated around the Z axis with respect to coarse motion stages.

FIG. 10B is a view for explaining the operation performed when the fine motion stage is rotated around the Y axis with respect to the coarse motion stages.

FIG. 10C is a view for explaining the operation performed when the fine motion stage is rotated around the X axis with respect to the coarse motion stages.

FIG. 11 is a view for explaining the operation performed when a center part of the fine motion stage is flexed in the +Z direction.

FIG. 12A is an oblique view that shows a tip part of a measuring arm.

FIG. 12B is a plan view, viewed from the +Z direction, of the upper surface of the tip part of the measuring arm.

FIG. 13A is a block diagram of an X head 77x.

FIG. 13B is for explaining the arrangement of the X head 77x and Y heads 77ya, 77yb inside the measuring arm.

FIG. 14A is a view for explaining a method of driving a wafer during a scanning exposure.

FIG. 14B is a view for explaining a method of driving the wafer during stepping.

FIG. 15 is a view that shows an exposure apparatus according to a modified example.

FIG. 16 is a block diagram that shows the principal components of a control system of the exposure apparatus shown in FIG. 15.

FIG. 17 is a view that shows a modified example of first and second drive parts of the fine motion stage drive system.

FIG. 18 is a schematic oblique view of a stage apparatus that has two stage units.

FIG. 19 is a flow chart that depicts one example of a process of fabricating a microdevice.

FIG. 20 depicts one example of the detailed process of wafer processing step described in FIG. 19.

### DESCRIPTION OF EMBODIMENTS

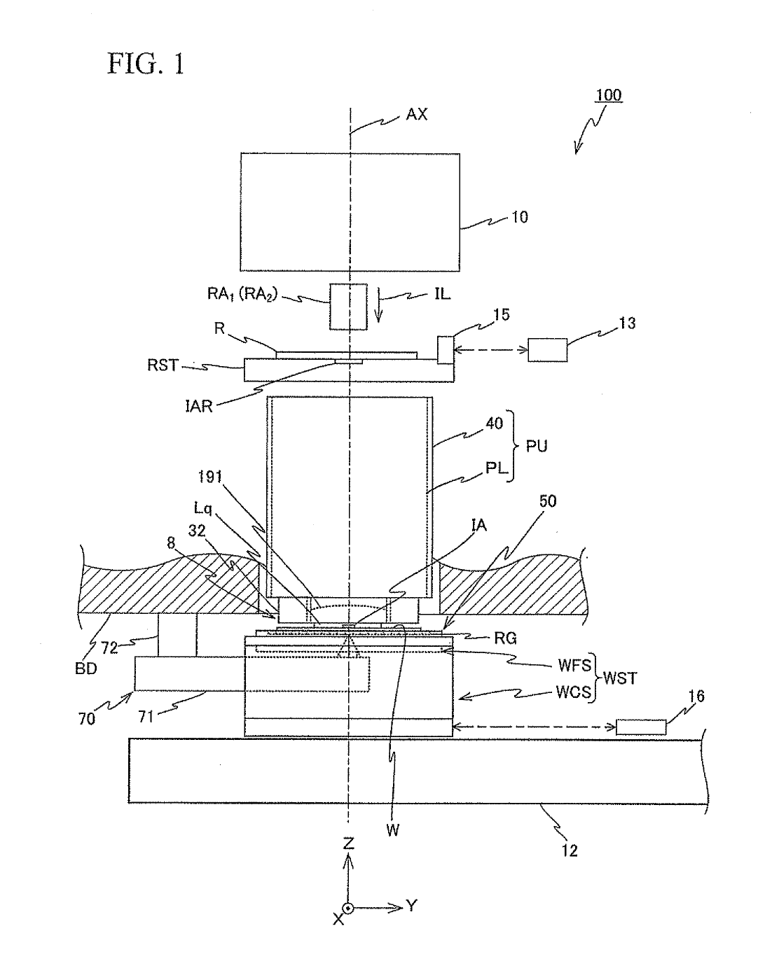

The following text explains an exposure apparatus and a device fabricating method of embodiments of the present invention, referencing FIG. 1 through FIG. 20.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

The exposure apparatus 100 comprises an illumination system 10, a reticle stage RST, a projection unit PU, a local liquid immersion apparatus 8, a stage apparatus 50 that has a fine motion stage WFS, and a control system that controls these elements. In FIG. 1, a wafer W is mounted on the fine motion stage WFS.

As disclosed in, for example, U.S. Patent Application Publication No. 2003/0025890, the illumination system 10 comprises an illumination optical system that comprises: a light source; a luminous flux intensity uniformizing optical system, which includes an optical integrator and the like; and a reticle blind (none of which are shown). The illumination system 10 illuminates, with illumination light IL (i.e., exposure light) at a substantially uniform luminous flux intensity, a slit shaped illumination area JAR, which is defined by a reticle blind (also called a masking system), on a reticle R. Here, as one example, ArF excimer laser light (with a wavelength of 193 nm) is used as the illumination light IL.

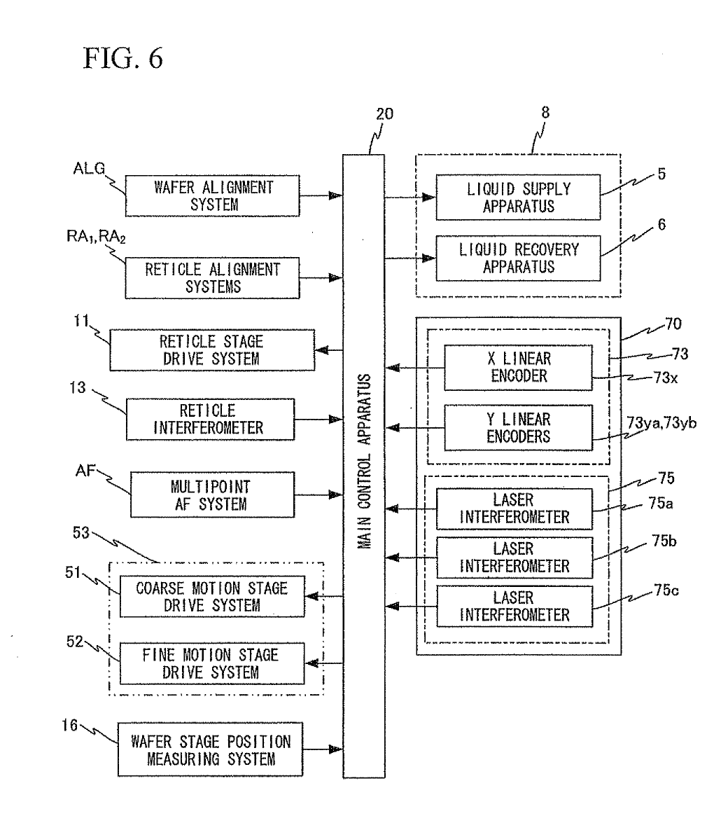

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 6) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

A reticle laser interferometer 13 (hereinbelow, called a “reticle interferometer”) continuously detects, with a resolving power of, for example, approximately 0.25 nm, the position (including rotation in the θz directions) of the reticle stage RST within the XY plane via movable mirrors 15, which are fixed to the reticle stage RST. Measurement values of the reticle interferometer 13 are sent to a main control apparatus 20 (not shown in FIG. 1; refer to FIG. 6).

The projection unit PU is disposed below the reticle stage RST in FIG. 1. The projection unit PU comprises a lens barrel 40 and the projection optical system PL, which comprises a plurality of optical elements that are held inside the lens barrel 40. A dioptric optical system that is, for example, double telecentric and has a prescribed projection magnification (e.g., ¼X, ⅕X, or ⅛X) is used as the projection optical system PL. Consequently, when the illumination light IL that emerges from the illumination system 10 illuminates the illumination area IAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area IAR (i.e., a reduced image of part of the circuit pattern) on the wafer W, which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR. Furthermore, by synchronously scanning the reticle stage RST and the fine motion stage WFS, the reticle R is moved relative to the illumination area IAR (i.e., the illumination light IL) in one of the scanning directions (i.e., one of the Y axial directions) and the wafer W is moved relative to the exposure area IA (i.e., the illumination light IL) in the other scanning direction (i.e., the other Y axial direction); thereby, a single shot region (i.e., block area) on the wafer W undergoes a scanning exposure and the pattern of the reticle R is transferred to that shot region. Namely, in the present embodiment, the pattern of the reticle R is created on the wafer W by the illumination system 10 and the projection optical system PL, and that pattern is formed on the wafer W by exposing a sensitive layer (i.e., a resist layer) on the wafer W with the illumination light IL.

The local liquid immersion apparatus 8 comprises a liquid supply apparatus 5 and a liquid recovery apparatus 6 (both of which are not shown in FIG. 1; refer to FIG. 6) as well as a nozzle unit 32. As shown in FIG. 1, the nozzle unit 32 is suspended from a main frame BD, which supports the projection unit PU and the like, via a support member (not shown) such that the nozzle unit 32 surrounds a lower end part of the lens barrel 40 that holds the optical element—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 6), which via the nozzle unit 32 supplies a liquid to the space between the tip lens 191 and the wafer W, and the liquid recovery apparatus 6 (refer to FIG. 6), which via the nozzle unit 32 recovers the liquid from the space between the tip lens 191 and the wafer W. At this time, the main control apparatus 20 controls the liquid supply apparatus 5 and the liquid recovery apparatus 6 such that the amount of the liquid supplied and the amount of the liquid recovered are always equal. Accordingly, a fixed amount of a liquid Lq (refer to FIG. 1) is always being replaced and held between the tip lens 191 and the wafer W. In the present embodiment, it is understood that pure water, through which ArF excimer laser light (i.e., light with a wavelength of 193 nm) transmits, is used as the abovementioned liquie.

As shown in FIG. 1, the stage apparatus 50 comprises: a base plate 12, which is supported substantially horizontally by a vibration isolating mechanism (not illustrated) on a floor surface; a wafer stage WST, which holds the wafer W and moves on the base plate 12; a wafer stage drive system 53 (refer to FIG. 6), which drives the wafer stage WST; and various measurement systems (16, 70) (refer to FIG. 6).

The base plate 12 comprises a member whose outer shape is shaped as a flat plate and whose upper surface is finished to an extremely high degree of flatness and serves as a guide surface when the wafer stage WST is moved.

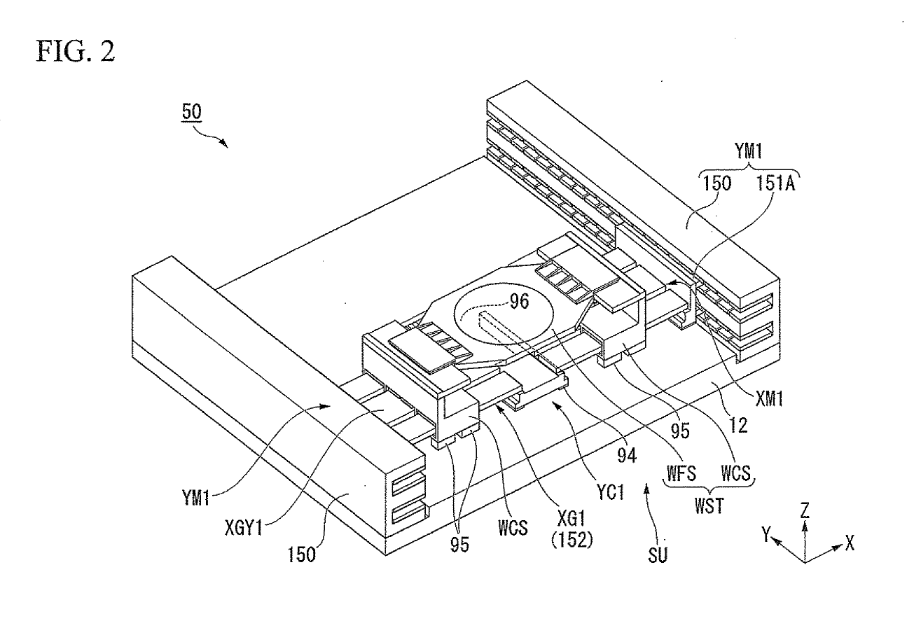

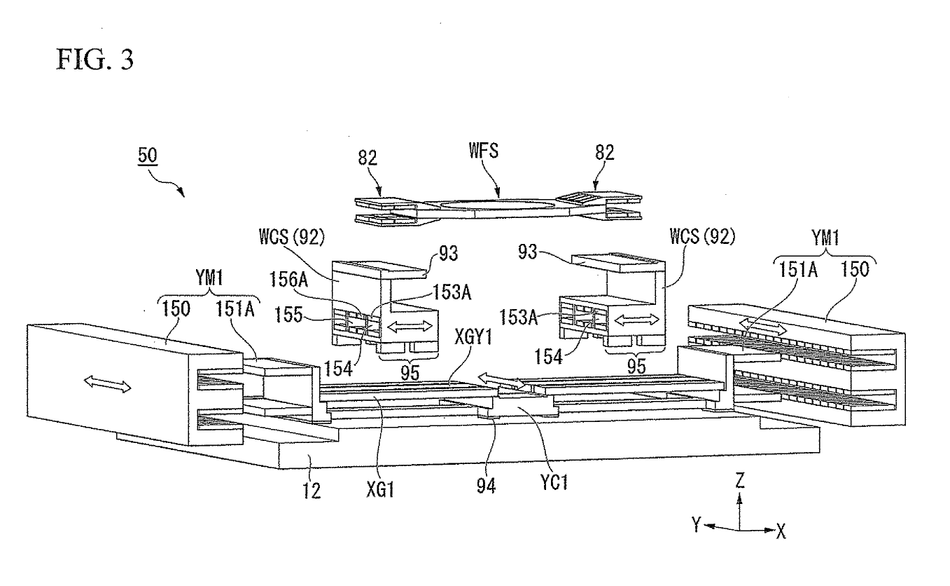

As shown in FIG. 2 and FIG. 3, the stage apparatus 50 comprises: a Y coarse motion stage YC1 (i.e., a first moving body), which moves by the drive of Y motors YM1; two X coarse motion stages WCS (i.e., second moving bodies), which move independently by the drive of X motors XM1; and the fine motion stage WFS, which holds the wafer W and is moveably supported by the X coarse motion stages WCS.

The Y coarse motion stage YC1 and the X coarse motion stages WCS constitute a stage unit SU.

The pair of X coarse motion stages WCS and the fine motion stage WFS constitute the wafer stage WST discussed above. The fine motion stage WFS is driven by a fine motion stage drive system 52 (i.e., a drive apparatus; refer to FIG. 6) in the X, Y, Z, θx, θy, and θz directions, which correspond to six degrees of freedom, with respect to the X coarse motion stages WCS.

The wafer stage position measuring system 16 measures the position within the XY plane (including the rotation in the θz directions) of the wafer stage WST (i.e., the coarse motion stages WCS). In addition, the fine motion stage position measuring system 70 (refer to FIG. 6) measures the position of the fine motion stage WFS in the directions corresponding to six degrees of freedom (i.e., the X, Y, Z, θx, θy, and θz directions). The measurement results of the wafer stage position measuring system 16 and the fine motion stage position measuring system 70 are supplied to the main control apparatus 20 (refer to FIG. 6), which uses these measurement results to control the positions of the coarse motion stages WCS and the fine motion stage WFS.

In the exposure apparatus 100, a wafer alignment system ALG (not shown in FIG. 1; refer to FIG. 6) is disposed at a position at which it is spaced apart by a prescribed distance from the center of the projection unit PU on the +Y side thereof. For example, an image processing type field image alignment (FIA) system is used as the alignment system ALG. When a wafer alignment (e.g., an enhanced global alignment (EGA)) is performed, the main control apparatus 20 uses the wafer alignment system ALG to detect a second fiducial mark, which is formed in a measuring plate on the fine motion stage WFS (discussed later), or an alignment mark on the wafer W. The captured image signal output by the wafer alignment system ALG is supplied to the main control apparatus 20 via a signal processing system (not shown). During the alignment of the target mark, the main control apparatus 20 calculates the X and Y coordinates in a coordinate system based on the results of the detection of the wafer alignment system ALG and the position of the fine motion stage WFS (i.e., the wafer W) during the detection.

In addition, in the exposure apparatus 100 of the present embodiment, an oblique incidence type multipoint focus position detection system AF (hereinbelow, abbreviated as “multipoint AF system”; not shown in FIG. 1; refer to FIG. 6), which is configured identically to the one disclosed in, for example, U.S. Pat. No. 5,448,332, is provided in the vicinity of the projection unit PU. The detection signal of the multipoint AF system. AF is supplied to the main control apparatus 20 (refer to FIG. 6) via an AF signal processing system (not shown). The main control apparatus 20 detects, based on the detection signal output by the multipoint AF system AF, the position of the front surface of the wafer W in the Z axial directions at each detection point of a plurality of detection points of the multipoint AF system AF (i.e., the surface position information) and, based on the results of that detection, performs a so-called focus and leveling control on the wafer W during the scanning exposure. Furthermore, the multipoint AF system may be provided in the vicinity of the wafer alignment system ALG, the surface position information (i.e., nonuniformity information) of the front surface of the wafer W during wafer alignment (EGA) may be acquired beforehand, and the so-called focus and leveling control may be performed on the wafer W during an exposure using the surface position information and a measurement value of a laser interferometer system 75 (refer to FIG. 6), which constitutes part of the fine motion stage position measuring system 70 (discussed below).

In addition, a pair of image processing type reticle alignment systems RA₁, RA₂ (in FIG. 1, the reticle alignment system RA₂ is hidden on the paper plane far side of the reticle alignment system RA₁), each of which uses light (in the present embodiment, the illumination light IL) of the exposure wavelength as the illumination light for alignment, is disposed above the reticle stage RST, as disclosed in detail in, for example, U.S. Pat. No. 5,646,413. The detection signals of the reticle alignment systems RA₁, RA₂ are supplied to the main control apparatus 20 (refer to FIG. 6) via a signal processing system (not shown).

FIG. 6 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 such as the local liquid immersion apparatus 8 discussed above, a coarse motion stage drive system 51, and the fine motion stage drive system 52.

Next, the configuration of each part of the stage apparatus 50 will be discussed in detail.

As shown in FIG. 2 and FIG. 3, the Y motors YM1 comprise stators 150, which are provided on both side ends of the base plate 12 in the X directions such that they extend in the Y directions, and sliders 151A, which are provided on both ends of the Y coarse motion stage YC1 in the X directions. The stators 150 comprise permanent magnets, which are arrayed in the Y directions, and the sliders 151A comprise coils, which are arrayed in the Y directions. Namely, the Y motors YM1 are moving coil type linear motors that drive both the wafer stage WST and the Y coarse motion stage YC1 in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stage WST, the Y coarse motion stage YC1, and the like in either one of the Y directions moves the stators 150, which serve as Y countermasses in the Y directions, in the other Y direction and is thereby offset by the law of conservation of momentum.

The Y coarse motion stage YC1 comprises X guides XG1 (i.e., guide members), which are provided between the sliders 151A, 151A and extend in the X directions, and is levitationally supported above the base plate 12 by a plurality of noncontact bearings, for example, air bearings 94, that is provided to a bottom surface of the Y coarse motion stage YC1.

The X guides XG1 are provided with stators 152, which constitute the X motors XM1. As shown in FIG. 3, sliders 153A of the X motors XM1 are provided in through holes 154, wherethrough the X guides XG1 are inserted and that pass through the X coarse motion stages WCS in the X directions.

The two X coarse motion stages WCS are each levitationally supported above the base plate 12 by a plurality of noncontact bearings, for example, air bearings 95, provided to the bottom surfaces of the X coarse motion stages WCS and move in the X directions independently of one another along the X guides XG1 by the drive of the X motors XM1. The Y coarse motion stage YC1 is provided with, in addition to the X guides XG1, X guides XGY1 whereto the stators of the Y linear motors that drive the X coarse motion stages WCS in the Y directions are provided. Furthermore, in each of the X coarse motion stages WCS, a slider 156A of the Y linear motor is provided in a through hole 155 (refer to FIG. 3), which passes through the X coarse motion stages WCS in the X directions. Furthermore, a configuration may be adopted wherein the X coarse motion stages WCS are supported in the Y directions by providing air bearings instead of providing the Y linear motors.

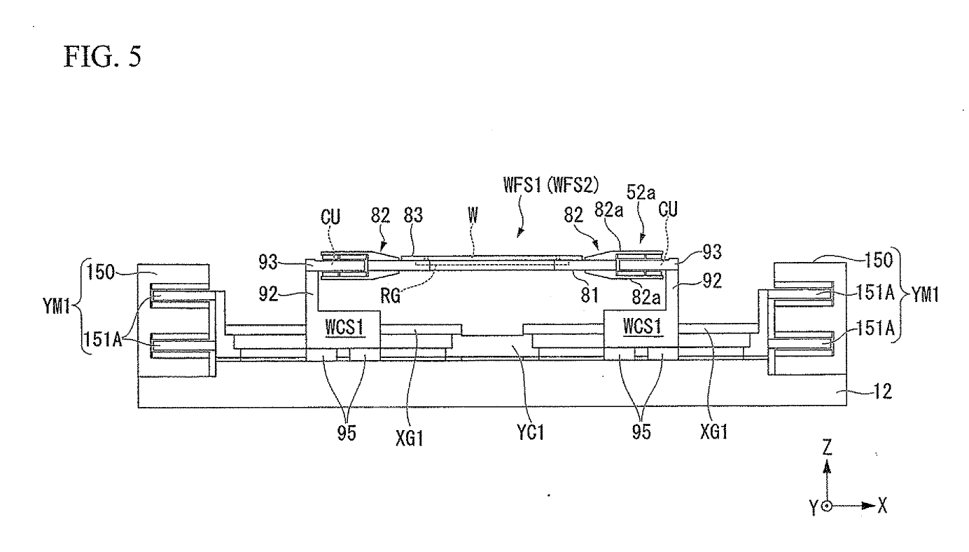

As shown in FIG. 3 and FIG. 5, a pair of sidewall parts 92 and a pair of stator parts 93, which are fixed to the upper surfaces of the sidewall parts 92, are provided to the outer side end parts in the X directions of the X coarse motion stages WCS. As a whole, each of the coarse motion stages WCS has a box shape with a small height and that is open at the center part of the upper surface in the X axial directions and both side surfaces in the Y axial directions. Namely, a space is formed in each of the coarse motion stages WCS such that the space passes through the inner part of the coarse motion stages WCS in the Y axial directions.

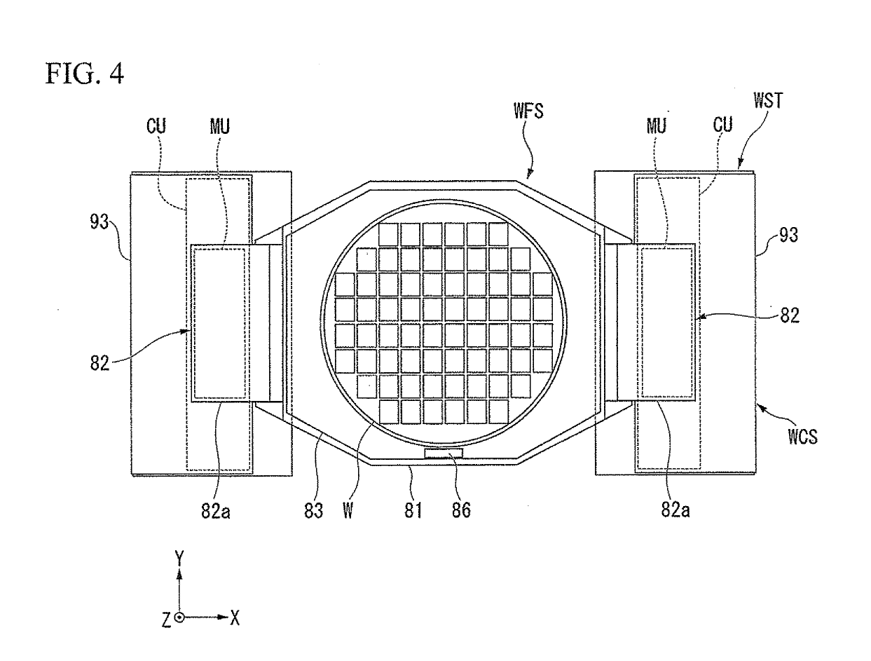

As shown in FIG. 3, FIG. 4, and FIG. 5, each stator part 93 of the pair of stator parts 93 comprises a plate shaped member whose outer shape is parallel to the XY plane; furthermore, each of the stator parts 93 houses a coil unit CU, which comprises a plurality of coils for driving the fine motion stage WFS. The fine motion stage WFS is noncontactually supported and driven by the coarse motion stages WCS.

As shown in FIG. 4 and FIG. 5, the fine motion stage WFS comprises a main body part 81, which consists of an octagonal plate shaped member whose longitudinal directions are oriented in the X axial directions in a plan view, and two slider parts 82, which are fixed to one end part and the other end part of the main body part 81 in the longitudinal directions.

Because an encoder system measurement beam (i.e., laser light), which is discussed below, must be able to travel through the inner part of the main body part 81, the main body part 81 is formed from a transparent raw material wherethrough light can transmit. In addition, to reduce the effects of air turbulence on the laser light that passes through the inner part of the main body part 81, the main body part 81 is formed as a solid block (i.e., its interior has no space). Furthermore, the transparent raw material preferably has a low coefficient of thermal expansion; in the present embodiment, as one example, synthetic quartz (i.e., glass) is used. Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS. Furthermore, the wafer holder may be formed integrally with the fine motion stage WFS and may be fixed to the main body part 81 by bonding and the like or via, for example, an electrostatic chuck mechanism or a clamp mechanism.

Furthermore, as shown in FIG. 4 and FIG. 5, a circular opening whose circumference is larger than the wafer W (i.e., the wafer holder) is formed in the center of the upper surface of the main body part 81 on the outer side of the wafer holder (i.e., the mounting area of the wafer W), and a plate 83, whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 4, an oblong measuring plate 86 that is long and thin in the X axial directions is installed in the −Y side end part of the plate 83 such that the front surface of the measuring plate 86 is substantially coplanar with the front surface of the plate 83, namely, the front surface of the wafer W. At least a pair of the first fiducial marks discussed above and a second fiducial mark, which is detected by a primary alignment system, are formed in the front surface of the measuring plate 86 (note that none of the first and second fiducial marks are shown).

As shown in FIG. 5, a two-dimensional grating RG (hereinbelow, simply called a “grating”) is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

The upper surface of the grating RG is covered by a protective member, for example, a cover glass (not shown). In the present embodiment, the vacuum chucking mechanism (discussed above), which chucks the wafer holder, is provided to the upper surface of the cover glass, which is a holding surface. Furthermore, in the present embodiment, the cover glass is provided such that it covers substantially the entire surface of the upper surface of the main body part 81, but the cover glass may be provided such that it covers only the part of the upper surface of the main body part 81 that includes the grating RG. In addition, the protective member (i.e., the cover glass) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As is clear from FIG. 5, the main body part 81 consists, as a whole, of an octagonal plate shaped member wherein overhanging parts that project from the outer sides of both end parts in the longitudinal directions are formed, and the center area wherein the grating RG is disposed is formed as a plate with a substantially uniform thickness.

Each of the slider parts 82 comprises plate shaped members 82a, which are positioned on both sides of the corresponding stator part 93 in the Z directions such that they sandwich the stator part 93, that are parallel to the XY plane. An end part of the stator part 93 of each of the coarse motion stages WCS is noncontactually inserted between the corresponding two plate shaped members 82a. In addition, each of the plate shaped members 82a houses a magnet unit MU, which is discussed below.

Here, as discussed above, both side surfaces of each of the coarse motion stages WCS in the Y axial directions are open; therefore, when the fine motion stage WFS is mounted to the coarse motion stages WCS, the fine motion stage WFS should be positioned in the Z axial directions such that each of the stator parts 93 is positioned between the two corresponding plate shaped members 82a, 82a; subsequently, the fine motion stage WFS should be moved (i.e., slid) in the Y axial directions.

Each of the fine motion stage drive systems 52 comprises a pair of the magnet units MU, which is provided to the corresponding slider part 82 discussed above, and the coil unit CU, which is provided to the corresponding stator part 93.

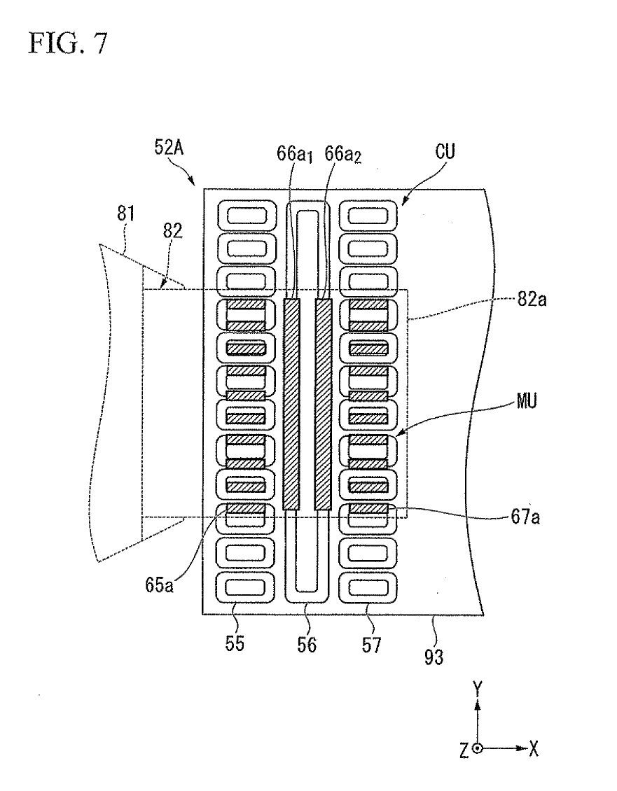

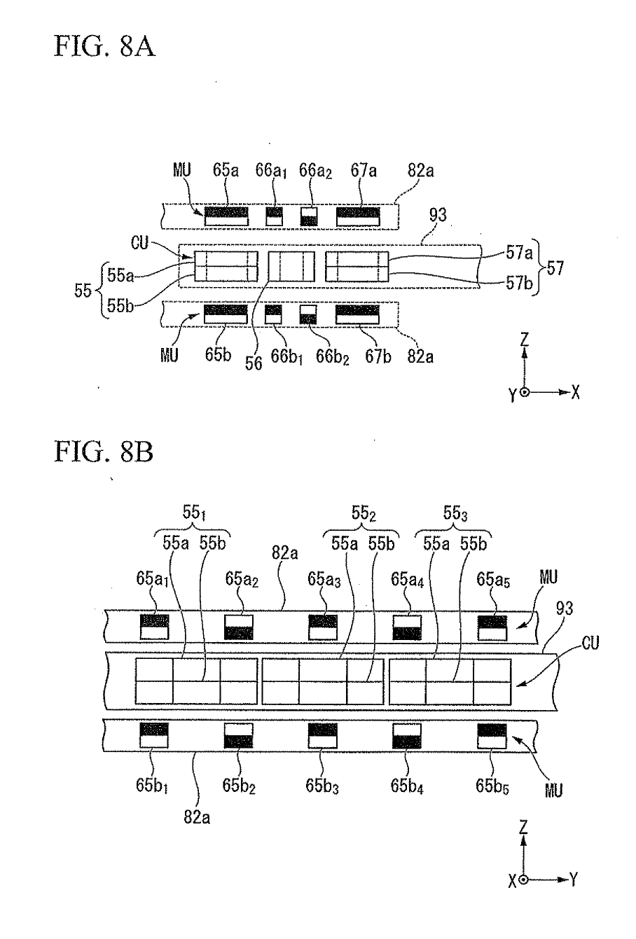

This will now be discussed in more detail. As shown in FIG. 7, FIG. 8A and FIG. 8B, a plurality of YZ coils 55 (herein, 12) and a plurality of YZ coils 57 (herein, 12) (hereinbelow, these are abbreviated as “coils” where appropriate), which are oblong in a plan view, are disposed as a two-column coil array, wherein the columns are disposed equispaced in the Y axial directions, such that the coils are spaced apart by a prescribed spacing in the X axial directions; furthermore, the YZ coils 55, 57 are disposed on the −X side end part inside the corresponding stator part 93. Each of the YZ coils 55 comprises an upper part winding 55a and a lower part winding 55b, which are oblong in a plan view and disposed such that they overlap in the vertical directions (i.e., the Z axial directions). In addition, one X coil 56 (hereinbelow, abbreviated as “coil” where appropriate), which in a plan view is a long, thin oblong whose longitudinal directions are oriented in the Y axial directions, is disposed inside the corresponding stator part 93 and between the columns of the two-column coil array discussed above. In this case, each of the columns of the two-column coil array and the X coil 56 are disposed equispaced in the X axial directions. Together, the two-column coil array and the X coil 56 constitute the coil unit CU.

Furthermore, the following text explains one of the stator parts 93 of the pair of stator parts 93 and the corresponding slider part 82 that is supported by that stator part 93; however, the other (i.e., the −X side) stator part 93 and slider part 82 are identically configured and function the same manner.

A plurality of permanent magnets 65a, 67a (herein, 10 of each), which are oblong in a plan view and whose longitudinal directions are oriented in the X axial directions, are disposed equispaced in the Y axial directions inside the +Z side plate shaped member 82a, which constitutes part of the corresponding slider part 82 of the fine motion stage WFS, thereby constituting a two-column magnet array. The columns of the two-column magnet array are disposed spaced apart by a prescribed spacing in the X axial directions. In addition, the columns of the two-column magnet array are disposed such that they oppose the coils 55, 57.

As shown in FIG. 8B, the plurality of the permanent magnets 65a is arrayed such that permanent magnets whose upper surface side (i.e., +Z side) is its N-pole and whose lower surface side (i.e., −Z side) is its S-pole and permanent magnets whose upper surface side (i.e., +Z side) is its S-pole and whose lower surface side (i.e., −Z side) is its N-pole alternate in the Y axial directions. The magnet column that comprises the plurality of the permanent magnets 67a is configured identically to the magnet column that comprises the plurality of the permanent magnets 65a.

In addition, two permanent magnets 66a1, 66a2, which are disposed spaced apart in the X axial directions and whose longitudinal directions are oriented in the Y axial directions, are disposed inside the plate shaped member 82a between the columns of the two-column magnet array discussed above such that they oppose the coil 56. As shown in FIG. 8A, the permanent magnet 66a1 is configured such that its upper surface side (i.e., its +Z side) is its N-pole and its lower surface side (i.e., −Z side) is its S-pole; furthermore, the permanent magnet 66a2 is configured such that its upper surface side (i.e., +Z side) is its S-pole and its lower surface side (i.e., −Z side) is its N-pole.

The plurality of the permanent magnets 65a, 67a and 66a1, 66a2 discussed above constitutes one of the magnet units MU.

As shown in FIG. 8A, permanent magnets 65b, 66b1, 66b2, 67b similarly are disposed inside the −Z side plate shaped member 82a with the same arrangement as in the +Z side plate shaped member 82a discussed above. These permanent magnets 65b, 66b1, 66b2, 67b constitute the other magnet unit MU. Furthermore, the permanent magnets 65b, 66b1, 66b2, 67b inside the −Z side plate shaped member 82a are disposed such that they overlap the magnets 65a, 66a1, 66a2, 67a on the paper plane far side in FIG. 7.

Here, as shown in FIG. 8B, in the fine motion stage drive system 52, the positional relationships (i.e., the individual spacings) in the Y axial directions between the plurality of permanent magnets and the plurality of YZ coils 55 are set such that, with regard to the plurality of permanent magnets disposed adjacently in the Y axial directions (i.e., permanent magnets 65a1-65a5 arranged in linear order in the Y axial directions), when the two adjacent permanent magnets 65a1 and 65a2 each oppose a winding part of a YZ coil 55₁, the adjacent permanent magnet 65a3 does not oppose a winding part of a YZ coil 55₂, which is adjacent to the YZ coil 55₁ discussed above (i.e., such that it opposes either the hollow at the center of the coil or the core around which the coil is wound, e.g., the iron core). Furthermore, each of the permanent magnets 65a4 and 65a5 opposes a winding part of a YZ coil 55₃, which is adjacent to the YZ coil 55₂. The spacings between the permanent magnets 65b, 67a, 67b in the Y axial directions are all the same (refer to FIG. 8B).

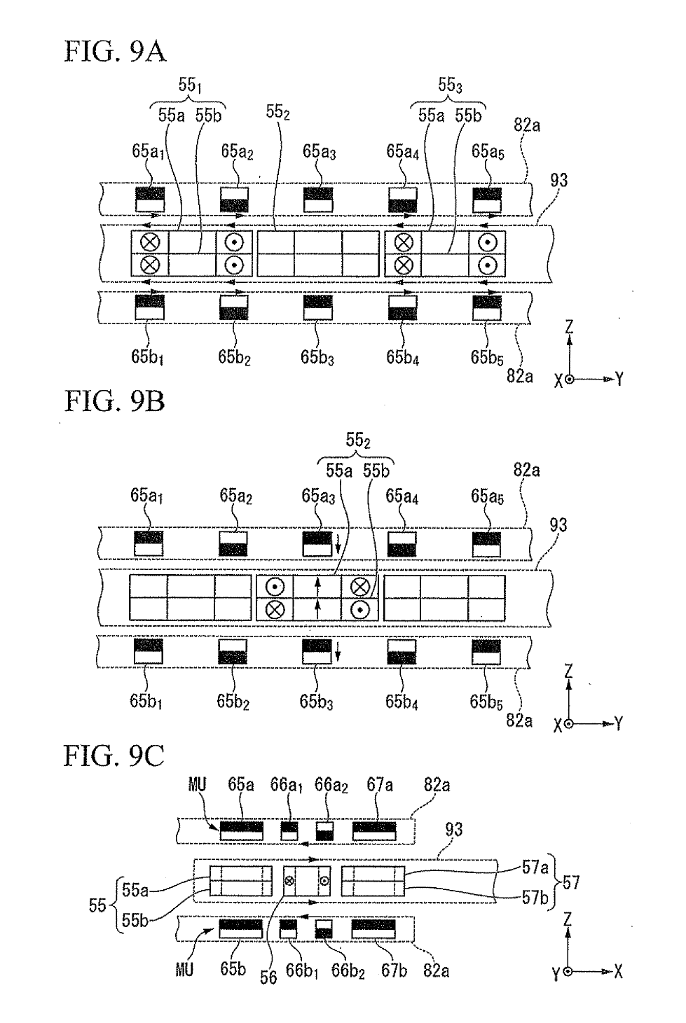

Accordingly, in the fine motion stage drive system 52, as shown in FIG. 9A and in the state shown in FIG. 8B as an example, if clockwise currents, viewed from the +Z direction, are supplied to each upper part winding and lower part winding of the coils 55₁, 55₃, then forces (i.e., Lorentz's forces) in the −Y direction will act on the coils 55₁, 55₃ and, in reaction thereto, forces in the +Y direction will act on the permanent magnets 65a, 65b. These forces act to move the fine motion stage WFS in the +Y direction with respect to the coarse motion stages WCS. If, on the other hand, counterclockwise currents, viewed from the +Z direction, are supplied to each of the coils 55₁, 55₃, then the fine motion stage WFS moves in the −Y direction with respect to the coarse motion stages WCS.

Supplying electric currents to the coils 57 induces an electromagnetic interaction between the permanent magnets 67 (67a, 67b), which makes it possible to drive the fine motion stage WFS in the Y axial directions. The main control apparatus 20 controls the position of the fine motion stage WFS in the Y axial directions by controlling the electric current supplied to each of the coils.

In addition, in the fine motion stage drive system 52, as shown in FIG. 9B and in the exemplary state shown in FIG. 8B, if a counterclockwise current, viewed from the +Z direction, is supplied to the upper part winding of the coil 55₂ and a clockwise current, viewed from the +Z direction, is supplied to the lower part winding of the coil 55₂, then an attraction force is generated between the coil 55₂ and the permanent magnet 65a3 and a repulsion force is generated between the coil 55₂ and a permanent magnet 65b3; furthermore, these attraction and repulsion forces move the fine motion stage WFS upward (i.e., in the +Z direction) with respect to the coarse motion stages WCS, namely, the forces levitate the fine motion stage WFS. The main control apparatus 20 controls the position of the fine motion stage WFS in the Z axial directions in the levitated state by controlling the electric currents supplied to each of the coils.

In addition, as shown in FIG. 9C and in the state shown in FIG. 8A, if a clockwise current, viewed from the +Z direction, is supplied to the coil 56, then a force in the +X direction acts on the coil 56 and, in reaction thereto, forces in the −X direction act on each of the permanent magnets 66a1, 66a2 and 66b1, 66b2, which moves the fine motion stage WFS in the −X direction with respect to the coarse motion stages WCS. In addition, if, on the other hand, a counterclockwise current, viewed from the +Z direction, is supplied to the coil 56, then forces in the +X direction act on the permanent magnets 66a1, 66a2 and 66b1, 66b2, which moves the fine motion stage WFS in the +X direction with respect to the coarse motion stages WCS. The main control apparatus 20 controls the position of the fine motion stage WFS in the X axial directions by controlling the electric currents supplied to each of the coils.

As is clear from the explanation above, in the present embodiment, the main control apparatus 20 drives the fine motion stage WFS in the Y axial directions by supplying an electric current to every other coil of the plurality of the YZ coils 55, 57 arrayed in the Y axial directions. In addition, in parallel therewith, the main control apparatus 20 levitates the fine motion stage WFS above the coarse motion stages WCS through generating driving forces in the Z axial directions that are separate from the driving forces in the Y axial directions by supplying electric currents to coils of the YZ coils 55, 57 that are not used to drive the fine motion stage WFS in the Y axial directions. Furthermore, by sequentially switching, in accordance with the position of the fine motion stage WFS in the Y axial directions, which of the coils are supplied with electric current, the main control apparatus 20 drives the fine motion stage WFS in the Y axial directions while maintaining the state wherein the fine motion stage WFS is levitated above the coarse motion stages WCS, namely, a noncontactual state. Furthermore, in the state wherein the fine motion stage WFS is levitated above the coarse motion stages WCS, the main control apparatus 20 can also drive the fine motion stage WFS independently in the X axial directions in addition to the Y axial directions.

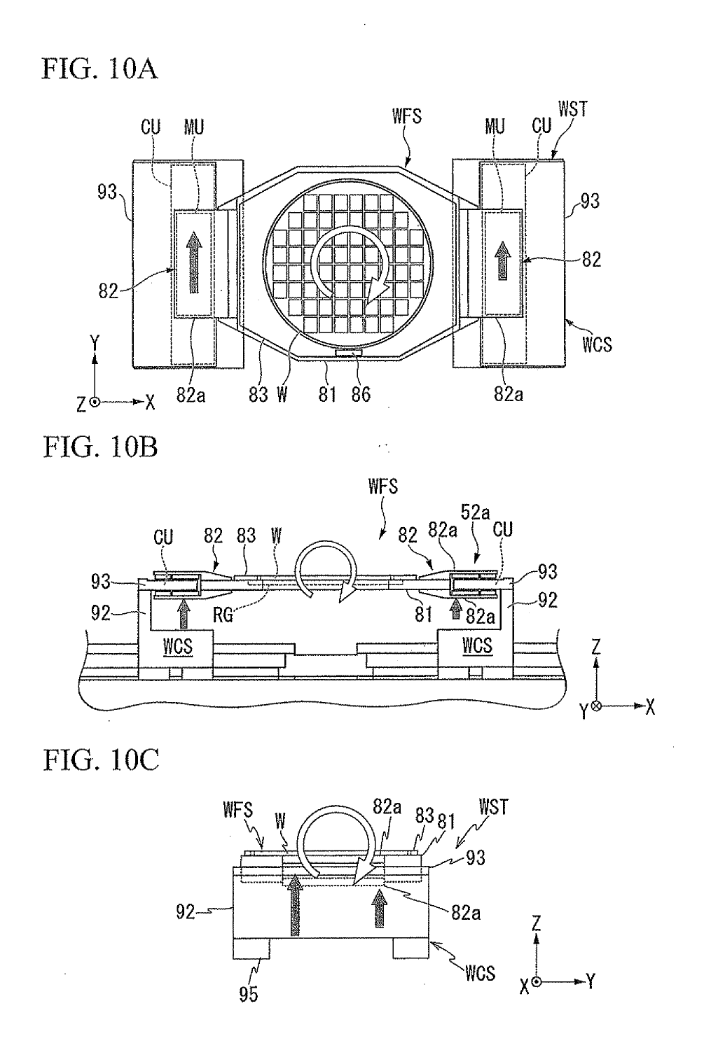

In addition, as shown in, for example, FIG. 10A, the main control apparatus 20 can rotate the fine motion stage WFS around the Z axis (i.e., can perform θz rotation; refer to the outlined arrow in FIG. 10A) by causing driving forces (i.e., thrusts) in the Y axial directions of differing magnitudes to act on the slider part 82 on the +X side and the slider part 82 on the −X side of the fine motion stage WFS (refer to the solid arrows in FIG. 10A). Furthermore, the fine motion stage WFS can be rotated counterclockwise around the Z axis by, in a method the reverse of that described in FIG. 10A, making the driving force that acts on the slider part 82 on the +X side larger than the driving force that acts on the slider part 82 on the −X side.

In addition, as shown in FIG. 10B, the main control apparatus 20 can rotate the fine motion stage WFS around the Y axis (i.e., can perform Oy drive; refer to the outlined arrow in FIG. 10B) by causing levitational forces of differing magnitudes to act on the slider part 82 on the +X side and the slider part 82 on the −X side of the fine motion stage WFS (refer to the solid arrows in FIG. 10B). Furthermore, the fine motion stage WFS can be rotated counterclockwise around the Y axis by, in a method the reverse of that described in FIG. 10B, making the levitational force that acts on the slider part 82 on the +X side larger than the levitational force that acts on the slider part 82 on the −X side.

Furthermore, as shown in, for example, FIG. 10C, the main control apparatus 20 can rotate the fine motion stage WFS around the X axis (i.e., can perform θx drive; refer to the outlined arrow in FIG. 10C) by causing levitational forces of differing magnitudes to act on the +Y side and −Y side slider parts 82 of the fine motion stage WFS (refer to the solid arrows in FIG. 10C). Furthermore, the fine motion stage WFS can be rotated counterclockwise around the X axis by, in a method the reverse of that described in FIG. 10C, making the levitational force that acts on the −Y side portion smaller than the levitational force that acts on the +Y side portion of the slider parts 82.

As is understood from the explanation above, in the present embodiment, the fine motion stage drive system 52 (i.e., first and second drive parts) can levitationally support the fine motion stage WFS in a noncontactual state above the coarse motion stages WCS and can drive the coarse motion stages WCS noncontactually in directions corresponding to six degrees of freedom (i.e., in the X, Y, Z, θx, θy, and θz directions).

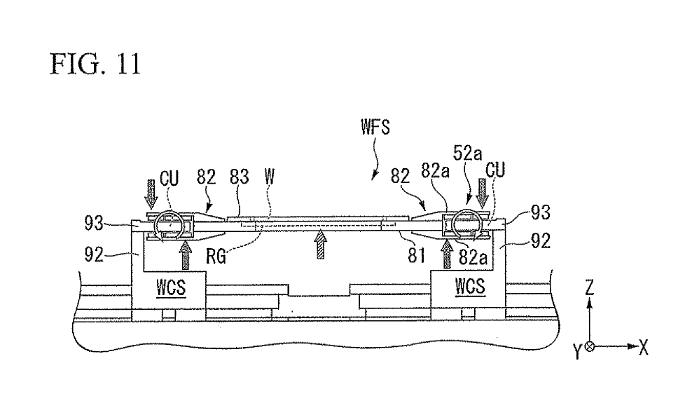

In addition, in the present embodiment, when levitational forces are caused to act on the fine motion stage WFS, the main control apparatus 20 can cause a rotational force around the Y axis to act on the +X side slider part 82 (refer to the outlined arrow in FIG. 11) at the same time that levitational forces act on the +X side slider part 82 (refer to the solid arrow in FIG. 11), as shown in, for example, FIG. 11, by supplying electric currents in opposite directions to the two columns of coils 55, 57 (refer to FIG. 7) disposed inside a stator part 93. Similarly, when levitational forces are caused to act on the fine motion stage WFS, the main control apparatus 20 can cause a rotational force around the Y axis to act on the slider parts 82 at the same time that levitational forces act on the slider parts 82 by supplying electric currents in opposite directions to the two columns of coils 55, 57 disposed inside a stator part 93b.

Namely, in the present embodiment, the first drive part, which exerts driving forces in the Y axial, X axial, Z axial, θy, and θx directions upon the +X side end part of the fine motion stage WFS, comprises the coil unit CU and the magnet units MU that constitute one part of the fine motion stage drive system 52; furthermore, the second drive part, which exerts driving forces in the Y axial, X axial, Z axial, θy, and θx directions upon the −X side end part of the fine motion stage WFS, comprises the coil unit CU and the magnet units MU that constitute one part of the fine motion stage drive system 52.

In addition, the main control apparatus 20 can flex in the +Z direction or the −Z direction (refer to the hatched arrow in FIG. 11) the center part of the fine motion stage WFS in the X axial directions by using the first and second drive parts to apply rotational forces around the Y axis (i.e., in the θy directions) to the pair of slider parts 82 in opposite directions. Accordingly, as shown in FIG. 11, it can ensure a degree of parallelism between the front surface of the wafer W and the XY plane (i.e., the horizontal plane) by flexing in the +Z direction (i.e., by causing to protrude) the center part of the fine motion stage WFS in the X axial directions and thereby canceling the flexure in the X axial directions of an intermediate portion of the fine motion stage WFS (i.e., the main body part 81) owing to the self weights of the wafer W and the main body part 81. Thereby, this aspect is particularly effective when, for example, the size of the wafer W or of the fine motion stage WFS is increased.

In addition, if the wafer W deforms owing to its self weight and the like, then the area that includes the irradiation area of the illumination light IL on the front surface of the wafer W mounted on the fine motion stage WFS (i.e., the exposure area IA) might not fall within the range of the depth of focus of the projection optical system PL; however, as in the case discussed above wherein the main control apparatus 20 flexes in the +Z direction the center part in the X axial directions of the fine motion stage WFS, the main control apparatus 20 can also deform the wafer W such that it becomes substantially flat by causing rotational forces around the Y axis to act, via the first and second drive parts, on the pair of slider parts 82 in opposite directions such that the area that includes the exposure area IA falls within the range of the depth of focus of the projection optical system PL. Furthermore, FIG. 11 shows an example wherein the fine motion stage WFS is flexed in the +Z direction (i.e., so as to form a convex shape), but it is also possible to flex the fine motion stage WFS in the opposite direction (i.e., so as to form a concave shape) by controlling the directions of the electric currents supplied to the coils.

In the exposure apparatus 100 of the present embodiment, when a step-and-scan type exposure operation is being performed on the wafer W, the main control apparatus 20 uses an encoder system 73 (refer to FIG. 6) of the fine motion stage position measuring system 70 (discussed below) to measure the position within the XY plane (including the position in the θz directions) of the fine motion stage WFS. The positional information of the fine motion stage WFS is sent to the main control apparatus 20, which, based thereon, controls the position of the fine motion stage WFS.

In contrast, when the wafer stage WST is outside of the measurement area of the fine motion stage position measuring system 70, the main control apparatus 20 uses the wafer stage position measuring system 16 (refer to FIG. 6) to measure the position of the wafer stage WST. As shown in FIG. 1, the wafer stage position measuring system 16 comprises laser interferometers, which radiate length measuring beams to reflective surfaces on the side surfaces of the coarse motion stages WCS, and measures the position within the XY plane (including the rotation in the θz directions) of the wafer stage WST. Furthermore, instead of using the wafer stage position measuring system 16 discussed above to measure the position within the XY plane of the wafer stage WST, some other measuring apparatus, for example, an encoder system, may be used. In such a case, for example, a two dimensional scale can be disposed on the upper surface of the base plate 12, and an encoder head can be attached to each of the bottom surfaces of the coarse motion stages WCS.

As shown in FIG. 1, the fine motion stage position measuring system 70 comprises a measuring arm 71, which is inserted in the space inside each of the coarse motion stages WCS in the state wherein the wafer stage WST is disposed below the projection optical system PL. The measuring arm 71 is supported in a cantilevered state by the main frame BD via a support part 72 (i.e., the vicinity of one-end part is supported).

The measuring arm 71 is a square columnar member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71 is formed from the identical raw material wherethrough the light transmits, for example, by laminating together a plurality of glass members. The measuring arm 71 is formed as a solid, excepting the portion wherein the encoder head (i.e., the optical system) is housed (discussed below). As discussed above, a tip part of the measuring arm 71 is inserted in the spaces of the coarse motion stages WCS in the state wherein the wafer stage WST is disposed below the projection optical system PL; furthermore, as shown in FIG. 1, the upper surface of the measuring arm 71 opposes the lower surface of the fine motion stage WFS (more accurately, the lower surface of the main body part 81; not shown in FIG. 1; refer to FIG. 5 and the like). The upper surface of the measuring arm 71 is disposed substantially parallel to the lower surface of the fine motion stage WFS in the state wherein a prescribed clearance, for example, approximately several millimeters, is formed between the upper surface of the measuring arm 71 and the lower surface of the fine motion stage WFS.

As shown in FIG. 6, the fine motion stage position measuring system 70 comprises the encoder system 73 and the laser interferometer system 75. The encoder system 73 comprises an X linear encoder 73x, which measures the position of the fine motion stage WFS in the X axial directions, and a pair of Y linear encoders 73ya, 73yb, which measures the position of the fine motion stage WFS in the Y axial directions. The encoder system 73 uses diffraction interference type heads with a configuration identical to that of the encoder head (herein below, abbreviated as “head” where appropriate) disclosed in, for example, U.S. Pat. No. 7,238,931 and U.S. Patent Application Publication No. 2007/288121. However, in the head of the present embodiment, the light source discussed above and a light receiving system (including a photodetector) are disposed outside of the measuring arm 71 (as discussed below), and only the optical system is disposed inside the measuring arm 71, namely, opposing the grating RG. Unless it is particularly necessary to use its full name, the optical system disposed inside the measuring arm 71 is called a head.

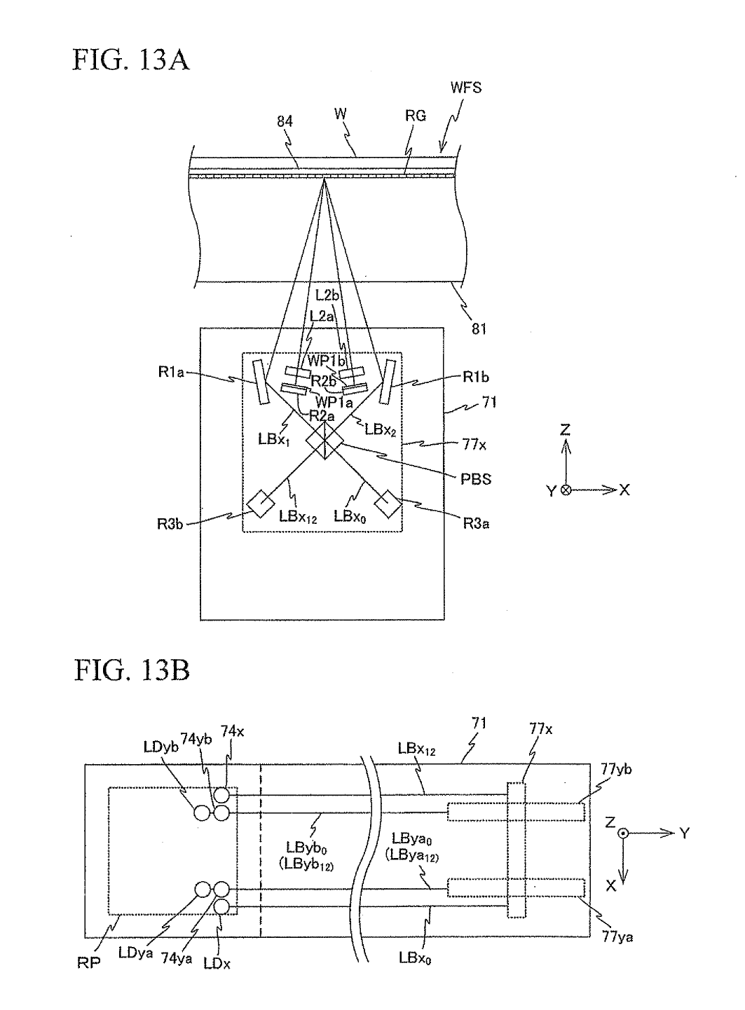

The encoder system 73 uses one X head 77x (refer to FIG. 13A and FIG. 13B) to measure the position of the fine motion stage WFS in the X axial directions, and uses a pair of Y heads 77ya, 77yb (refer to FIG. 13B) to measure the position of the fine motion stage WFS in the Y axial directions. Namely, the X linear encoder 73x (discussed above) comprises the X head 77x that uses the X diffraction grating of the grating RG to measure the position of the fine motion stage WFS in the X axial directions, and the pair of Y linear encoders 73ya, 73yb comprises the pair of Y heads 77ya, 77yb that uses the Y diffraction grating of the grating RG to measure the position of the fine motion stage WFS in the Y axial directions.

Here, the configuration of the three heads 77x, 77ya, 77yb that constitute the encoder system 73 will be explained. FIG. 13A shows a schematic configuration of the X head 77x, which represents all three of the heads 77x, 77ya, 77yb. In addition, FIG. 13B shows the arrangement of the X head 77x and the Y heads 77ya, 77yb inside the measuring arm 71.

As shown in FIG. 13A, the X head 77x comprises a polarizing beam splitter PBS, a pair of reflective mirrors R1a, R1b, a pair of lenses L2a, L2b, a pair of quarter wave plates WP1a, WP1b (hereinbelow, denoted as λ/4 plates), a pair of reflective mirrors R2a, R2b, and a pair of reflective mirrors R3a, R3b; furthermore, these optical elements are disposed with prescribed positional relationships. The optical systems of the Y heads 77ya, 77yb also have the same configuration. As shown in FIG. 13A and FIG. 13B, the X head 77x and the Y heads 77ya, 77yb are each unitized and fixed inside the measuring arm 71.

As shown in FIG. 13B, in the X head 77x (i.e., the X encoder 73x), a light source LDx, which is provided to the upper surface of the −Y side end part of the measuring arm 71 (or there above), emits in the −Z direction a laser beam LBx₀, the laser beam LBx₀ transits a reflective surface RP, which is provided to part of the measuring arm 71 such that the reflective surface RP is tilted at a 45° angle with respect to the XY plane, and the optical path of the laser beam LBx₀ is thereby folded in a direction parallel to the Y axial directions. The laser beam LBx₀ advances parallel to the Y axial directions through the solid portion inside the measuring arm 71 and reaches the reflective mirror R3a (refer to FIG. 13A). Furthermore, the reflective mirror R3a folds the optical path of the laser beam LBx₀, and the laser beam LBx₀ thereby impinges the polarizing beam splitter PBS. The polarizing beam splitter PBS polarizes and splits the laser beam LBx₀, which becomes two measurement beams LBx₁, LBx₂. The measurement beam LBx₁, which transmits through the polarizing beam splitter PBS, reaches the grating RG, which is formed in the fine motion stage WFS, via the reflective mirror R1a; furthermore, the beam LBx₂, which is reflected by the polarizing beam splitter PBS, reaches the diffraction grating RG via the reflective mirror R1b. Furthermore, “polarization splitting” herein means the splitting of the incident beam into a P polarized light component and an S polarized light component.

Diffraction beams of a prescribed order (e.g., first order diffraction beams), which are generated by the grating RG as a result of the radiation of the beams LBx₁, LBx₂, transit the lenses L2a, L2b, are converted to circularly polarized beams by the λ/4 plates WP1a, WP1b, are subsequently reflected by the reflective mirrors R2a, R2b, pass once again through the λ/4 plates WP1a, WP1b, and reach the polarizing beam splitter PBS by tracing the same optical path as the forward path, only in reverse.

The polarized directions of each of the two first order diffraction beams that reach the polarizing beam splitter PBS are rotated by 90° with respect to the original directions. Consequently, the first order diffraction beams of the measurement beams LBx₁, LBx₂ are combined coaxially as a combined beam LBx₁₂. The reflective mirror R3b folds the optical path of the combined beam LBx₁₂ such that it is parallel to the Y axis, after which the combined beam LBx₁₂ travels parallel to the Y axis inside the measuring arm 71, transits the reflective surface RP (discussed above), and is sent to an X light receiving system 74x, which is provided to the upper surface of the Y side end part of the measuring arm 71 (or there above), as shown in FIG. 13B.

In the X light receiving system 74x, the first order diffraction beams of the measurement beams LBx₁, LBx₂, which were combined into the combined beam LBx₁₂, are aligned in polarization directions by a polarizer (i.e., an analyzer), which is not shown, and therefore interfere with one another to form an interfered beam, which is detected by the photodetector (not shown) and then converted to an electrical signal that corresponds to the intensity of the interfered beam. Here, when the fine motion stage WFS moves in either of the measurement directions (in this case, the X axial directions), the phase difference between the two beams changes, and thereby the intensity of the interfered beam changes. These changes in the intensity of the interfered beam are supplied to the main control apparatus 20 (refer to FIG. 6) as the positional information in the X axial directions of the fine motion stage WFS.

As shown in FIG. 13B, laser beams LBya₀, LByb₀ are emitted from light sources LDya, LDyb and the reflective surface RP (discussed above) folds the optical paths of the laser beams LBya₀, LByb₀ by 90°, after which the laser beams LBya₀, LByb₀ are parallel to the Y axis and enter into the Y heads 77ya, 77yb. Combined beams LBya₁₂, LByb₁₂. of the first order diffraction beams, which have been polarized and split by the polarizing beam splitters and the grating RG (i.e., the Y diffraction grating) as discussed above, are output from the Y heads 77ya, 77yb, and return to Y light receiving systems 74ya, 74yb. Here, the laser beams LBya₀, LByb₀, which were emitted from the light sources LDya, LDyb, and the combined beams LBya₁₂, LByb₁₂, which return to the Y light receiving systems 74ya, 74yb, travel with overlapping optical paths in the directions perpendicular to the paper plane in FIG. 13B. In addition, as discussed above, inside the Y heads 77ya, 77yb, the optical paths of the laser beams LBya₀, LByb₀ emitted from the light sources and the optical paths of the combined beams LBya₁₂, LByb₁₂ that return to the Y light receiving systems 74ya, 74yb are folded as appropriate (not shown) such that those optical paths are parallel and spaced apart in the Z axial directions.

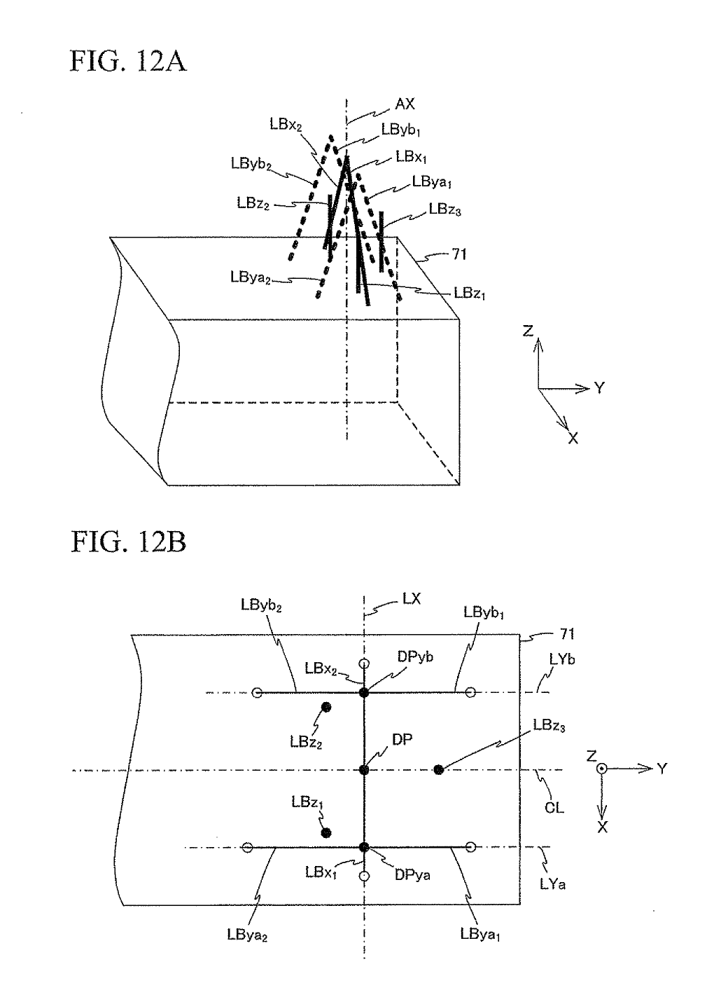

FIG. 12A is an oblique view of the tip part of the measuring arm 71, and FIG. 12B is a plan view, viewed from the +Z direction, of the upper surface of the tip part of the measuring arm 71. As shown in FIG. 12A and FIG. 12B, the X head 77x radiates the measurement beams LBx₁, LBx₂ (indicated by solid lines in FIG. 12A) from two points (refer to the white circles in FIG. 12B), which are equidistant from a centerline CL of the measuring arm 71 along a straight line LX parallel to the X axis, to the identical irradiation point on the grating RG (refer to FIG. 13A). The irradiation point of the measurement beams LBx₁, LBx₂, namely, the detection point of the X head 77x (refer to symbol DP in FIG. 12B) coincides with the exposure position (refer to FIG. 1), which is the center of the irradiation area IA (i.e., the exposure area) of the illumination light IL radiated to the wafer W. Furthermore, although the measurement beams LBx₁, LBx₂ are in actuality refracted by, for example, the interface surface between the main body part 81 and the air layer, this aspect is shown in a simplified form in FIG. 13A and the like.

As shown in FIG. 13B, the two Y heads 77ya, 77yb are disposed on opposite sides of the centerline CL, one on the +X side and one on the −X side. As shown in FIG. 12A and FIG. 12B, the Y head 77ya radiates measurement beams LBya₁, LBya₂, which are indicated by broken lines in FIG. 12A, from two points (refer to the white circles in FIG. 12B), which are equidistant from the straight line LX along a straight line LYa, to a common irradiation point on the grating RG. The irradiation point of the measurement beams LBya₁, LBya₂, namely, the detection point of the Y head 77ya, is indicated by a symbol DPya in FIG. 12B.

The Y head 77yb radiates measurement beams LByb₁, LByb₂ from two points (refer to the white circles in FIG. 12B), which are symmetric to the emitting points of the measurement beams LBya₁, LBya₂ of the Y head 77ya with respect to the centerline CL, to a common irradiation point DPyb on the grating RG. As shown in FIG. 12B, the detection points DPya, DPyb of the Y heads 77ya, 77yb are disposed along the straight line LX, which is parallel to the X axis.

Here, the main control apparatus 20 determines the position of the fine motion stage WFS in the Y axial directions based on the average of the measurement values of the two Y heads 77ya, 77yb. Accordingly, in the present embodiment, the position of the fine motion stage WFS in the Y axial directions is measured such that the midpoint DP of the detection points DPya, DPyb substantially serves as the measurement point. The midpoint DP coincides with the irradiation point of the measurement beams LBx₁, LBx₂ on the grating RG.

Namely, in the present embodiment, the positional measurements of the fine motion stage WFS in the X axial directions and the Y axial directions have a common detection point and this detection point coincides with the exposure position, which is the center of the irradiation area IA (i.e., the exposure area) of the illumination light IL radiated to the wafer W. Accordingly, in the present embodiment, the main control apparatus 20 can use the encoder system 73 to continuously measure—directly below the exposure position (i.e., on the rear surface side of the fine motion stage WFS)—the position of the fine motion stage WFS within the XY plane when the pattern of the reticle R is transferred to a prescribed shot region on the wafer W mounted on the fine motion stage WFS. In addition, the main control apparatus 20 measures the amount of rotation of the fine motion stage WFS in the θz directions based on the difference in the measurement values of the two Y heads 77ya, 77yb.

As shown in FIG. 12A, the laser interferometer system 75 causes three length measuring beams LBz₁, LBz₂, LBz₃ to emerge from the tip part of the measuring arm 71 and impinge the lower surface of the fine motion stage WFS. The laser interferometer system 75 comprises three laser interferometers 75a-75c (refer to FIG. 6), each of which radiates one of these three length measuring beams LBz₁, LBz₂, LBz₃.

As shown in FIG. 12A and FIG. 12B, in the laser interferometer system 75, the center of gravity of the three length measuring beams LBz₁, LBz₂, LBz₃ coincides with the exposure position, which is the center of the irradiation area IA (i.e., the exposure area), and the length measuring beams LBz₁, LBz₂, LBz₃ are emitted parallel to the Z axis from three points that correspond to the vertices of an isosceles triangle (or a regular triangle). In this case, the emitting point (i.e., the irradiation point) of the length measuring beam LBz₃ is positioned on the centerline CL and the emitting points (i.e., the irradiation points) of the remaining length measuring beams LBz₁, LBz₂ are equidistant from the centerline CL. In the present embodiment, the main control apparatus 20 uses the laser interferometer system 75 to measure the position in the Z axial directions and the amounts of rotation in the θz and θy directions of the fine motion stage WFS. Furthermore, the laser interferometers 75a-75c are provided to the upper surface of the −Y side end part of the measuring arm 71 (or there above). The length measuring beams LBz₁, LBz₂, LBz₃, which are emitted in the −Z direction from the laser interferometers 75a-75c transit the reflective surface RP (discussed above), travel along the Y axial directions inside the measuring arm 71, wherein their optical paths are folded, and emerge from the three points discussed above.

In the present embodiment, a wavelength selecting filter (not shown), which transmits the measurement beams from the encoder system 73 but hinders the transmission of the length measuring beams from the laser interferometer system 75, is provided to the lower surface of the fine motion stage WFS. In this case, the wavelength selecting filter serves double duty as the reflective surface of the length measuring beams from the laser interferometer system 75.

As can be understood from the explanation above, using the encoder system 73 of the fine motion stage position measuring system 70 and the laser interferometer system 75, the main control apparatus 20 can measure the position of the fine motion stage WFS in directions corresponding to six degrees of freedom. In this case, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS within the XY plane (including the θz directions). In addition, because the detection point of the encoder system 73 on the grating in the X axial directions and in the Y axial directions and the detection point of the laser interferometer system 75 on the lower surface of the fine motion stage WFS in the Z axial directions substantially coincide with the center (i.e., the exposure position) of the exposure area IA, so-called Abbé error is suppressed to such a degree that it is substantially inconsequential. Accordingly, using the fine motion stage position measuring system 70, the main control apparatus 20 can measure, with high accuracy, the position of the fine motion stage WFS in the X axial directions, the Y axial directions, and the Z axial directions without Abbé error.

In the exposure apparatus 100 of the present embodiment configured as discussed above, when a device is to be fabricated, the main control apparatus 20 first uses the wafer alignment system ALG to detect the second fiducial mark on the measuring plate 86 of the fine motion stage WFS. Next, the main control apparatus 20 uses the wafer alignment system ALG to perform wafer alignment (e.g., enhanced global alignment (EGA) and the like disclosed in, for example, U.S. Pat. No. 4,780,617) and the like. Furthermore, in the exposure apparatus 100 of the present embodiment, the wafer alignment system ALG is disposed spaced apart from the projection unit PU in the Y axial directions, and therefore the encoder system (i.e., the measuring arm 71) of the fine motion stage position measuring system 70 cannot measure the position of the fine motion stage WFS when wafer alignment is being performed. Accordingly, it is understood that the wafer is aligned while measuring the position of the wafer W (i.e., the fine motion stage WFS) via a laser interferometer system (not shown), as in the wafer stage position measuring system 16 discussed above. In addition, because the wafer alignment system ALG and the projection unit PU are spaced apart, the main control apparatus 20 converts the array coordinates of each of the shot regions on the wafer W, which were obtained as a result of the wafer alignment, to array coordinates wherein the second fiducial mark serves as a reference.

Furthermore, prior to the start of an exposure, the main control apparatus 20 uses the pair of reticle alignment systems RA₁, RA₂, the pair of first fiducial marks on the measuring plate 86 of the fine motion stage WFS, and the like, all of which were discussed above, to perform a reticle alignment using a procedure identical to that of a regular scanning stepper (e.g., the procedure disclosed in U.S. Pat. No. 5,646,413). Furthermore, based on the results of the reticle alignment and of the wafer alignment (i.e., the array coordinates of each shot region on the wafer W wherein the second fiducial mark serves as a reference), the main control apparatus 20 performs step-and-scan type exposure operations to transfer the pattern of the reticle R to the plurality of shot regions on the wafer W. These exposure operations are performed by repetitively and alternately performing a scanning exposure operation, which synchronously moves the reticle stage RST and the wafer stage WST as discussed above, and an inter-shot movement operation (i.e., stepping), which moves the wafer stage WST to an acceleration start position for exposing a shot region. In this case, the scanning exposure is performed by an immersion exposure. In the exposure apparatus 100 of the present embodiment, during the sequence of exposure operations discussed above, the main control apparatus 20 uses the fine motion stage position measuring system 70 to measure the position of the fine motion stage WFS (i.e., the wafer W) and, based on this measurement result, controls the position of the wafer W.

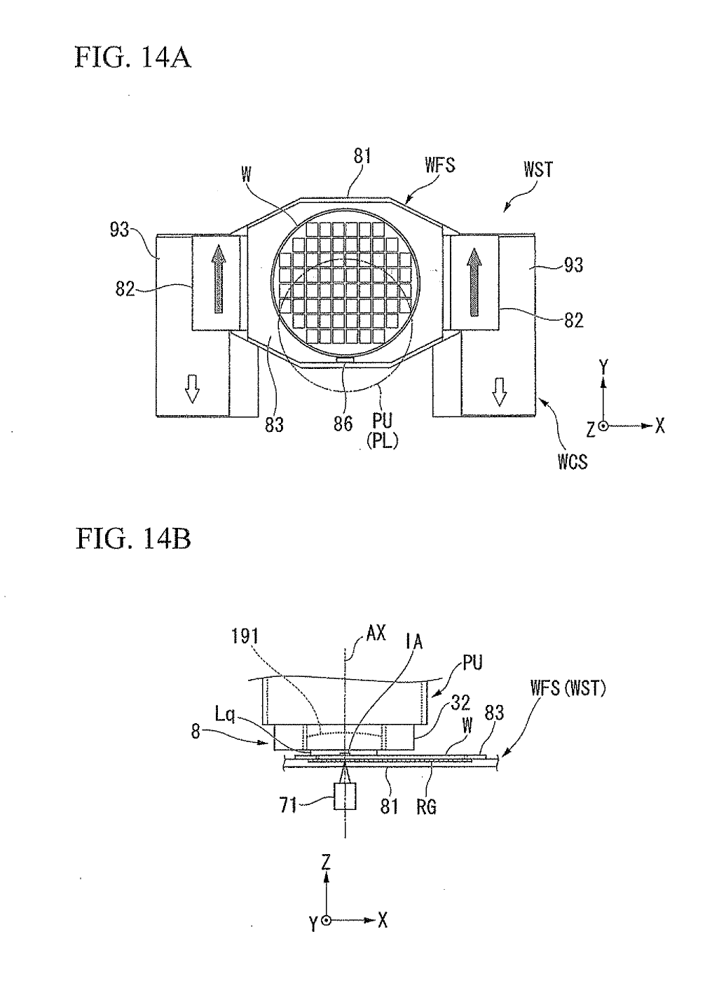

Furthermore, during the scanning exposure operation discussed above, the wafer W must be scanned in the Y axial directions at a high acceleration; however, in the exposure apparatus 100 of the present embodiment, as shown in FIG. 14A, the main control apparatus 20 scans the wafer W in the Y axial directions by driving only the fine motion stage WFS in the Y axial directions (refer to the solid arrows in FIG. 14A; and, as needed, in the directions corresponding to the other five degrees of freedom) without, as a rule, driving the coarse motion stages WCS. This is because to drive the wafer W at high acceleration, it is advantageous to drive the wafer W using only the fine motion stage WFS, which is lighter than the coarse motion stages WCS. In addition, as discussed above, the position measurement accuracy of the fine motion stage position measuring system 70 is higher than that of the wafer stage position measuring system 16, and therefore it is advantageous to drive the fine motion stage WFS during the scanning exposure. Furthermore, during the scanning exposure, the action of the reaction force (refer to the outlined arrows in FIG. 14A) generated by the drive of the fine motion stage WFS drives the coarse motion stages WCS in a direction opposite that of the fine motion stage WFS. Namely, the coarse motion stages WCS function as countermasses and conserve the momentum of the system that constitutes the entire wafer stage WST, and thereby the center of gravity does not move; therefore, the problem wherein, for example, a bias load acts on the base plate 12 owing to the drive of the fine motion stage WFS during a scan does not arise.

Moreover, when the inter-shot movement operation (i.e., stepping) is performed in the X axial directions, the fine motion stage WFS can move in the X axial directions by only a small amount; therefore, as shown in FIG. 14B, the main control apparatus 20 moves the wafer W in the X axial directions by driving the coarse motion stages WCS in the X axial directions.

According to the exposure apparatus 100 of the present embodiment as explained above, the fine motion stage WFS is supported noncontactually such that the fine motion stage drive system 52—more accurately, the first and second drive parts that constitute one part of the fine motion stage drive system 52—that constitutes part of the wafer stage drive system 53 is capable of moving relative to the coarse motion stages WCS within a plane parallel to the XY plane. Furthermore, the first and second drive parts cause driving forces in the Y axial, X axial, Z axial, θy, and θx directions to act on one end part and an other end part in the X axial directions of the fine motion stage WFS. By controlling the magnitude and/or the direction of each electric current supplied to the coils of the coil units CU discussed above, the main control apparatus 20 independently controls the magnitude of each of the driving forces and the direction in which each of the driving forces is generated. Accordingly, the first and second drive parts can not only drive the fine motion stage WFS in directions corresponding to six degrees of freedom—that is, in the Y, X, and Z axial directions and θz, θy, and θx directions—but can simultaneously deform the fine motion stage WFS (and the wafer W held thereby) into a concave shape or a convex shape within a plane perpendicular to the Y axis (i.e., the XZ plane) by causing driving forces in the θy directions to act in opposite directions on the one end part and the other end part in the X axial directions of the fine motion stage WFS. In other words, if the fine motion stage WFS (and the wafer W held thereby) deforms owing to its self weight and the like, that deformation can be corrected.

In addition, according to the exposure apparatus 100 of the present embodiment, the main control apparatus 20 uses the encoder system 73 of the fine motion stage position measuring system 70 comprising the measuring arm 71 discussed above to measure the position of the fine motion stage WFS within the XY plane. In this case, because the heads of the fine motion stage position measuring system 70 are disposed in the spaces of the coarse motion stages WCS, a space exists only between these heads and the fine motion stage WFS. Accordingly, the heads can be disposed proximate to the fine motion stage WFS (i.e., the grating RG), which makes it possible to use the fine motion stage position measuring system 70 to measure with high accuracy the position of the fine motion stage WFS and, in turn, for the main control apparatus 20 to drive with high accuracy the fine motion stage WFS via the fine motion stage drive system 52 (and the coarse motion stage drive system 51). In addition, in this case, the irradiation point on the grating RG of each measurement beam emerging from the measuring arm 71 of each head of the encoder system 73 and the laser interferometer system 75—such systems constituting the fine motion stage position measuring system 70—coincides with the center (i.e., the exposure position) of the irradiation area IA (i.e., the exposure area) of the exposure light IL radiated to the wafer W. Accordingly, the main control apparatus 20 can measure the position of the fine motion stage WFS with high accuracy without being affected by so-called Abbé error. In addition, disposing the measuring arm 71 directly below the grating RG makes it possible to greatly shorten the in-air optical path lengths of the measurement beams of the heads of the encoder system 73, which in turn reduces the effects of air turbulence and makes it possible to measure the position of the fine motion stage WFS with high accuracy.

In addition, according to the exposure apparatus 100 of the present embodiment, the fine motion stage WFS can be accurately driven, which makes it possible to accurately drive the wafer W mounted on the fine motion stage WFS synchronously with the reticle stage RST (i.e., the reticle R) and thereby to accurately transfer the pattern on the reticle R to the wafer W via a scanning exposure. In addition, because it is also possible to correct the flexure of the fine motion stage WFS and the wafer W, it is possible during a scanning exposure to maintain the area that includes the irradiation area of the illumination light IL on the front surface of the wafer W (i.e., the exposure area IA) within the range of the depth of focus of the projection optical system PL, and thereby to perform an exposure with high accuracy without any of the exposures failing owing to defocusing.

Furthermore, in the abovementioned embodiment, the wafer W is aligned while its position (i.e., the position of the fine motion stage WFS) is measured via the laser interferometer system (not shown), but the present invention is not limited thereto; for example, a second fine motion stage position measuring system, which includes a measuring arm that is identically configured to the measuring arm 71 of the fine motion stage position measuring system 70 discussed above, may be provided in the vicinity of the wafer alignment system ALG and used to measure the position of a fine motion stage within the XY plane during a wafer alignment.

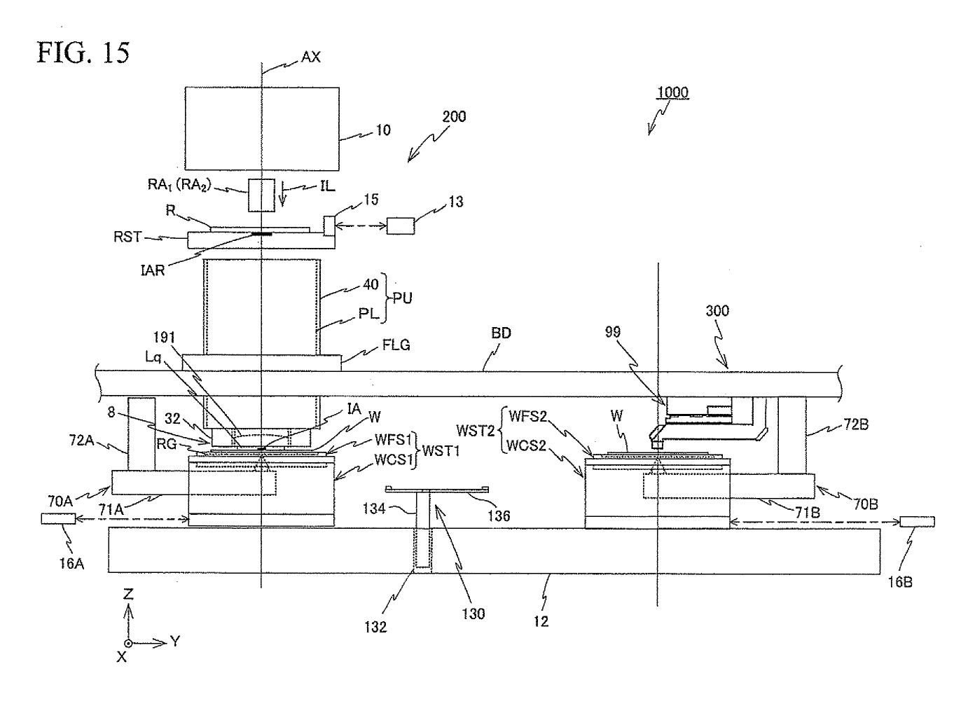

FIG. 15 shows the configuration of an exposure apparatus 1000 according to a modified example that comprises the second fine motion stage position measuring system of the type described above. The exposure apparatus 1000 is a twin wafer stage type exposure apparatus that comprises an exposure station 200, wherein the projection unit PU is disposed, and a measurement station 300, wherein the alignment system ALG is disposed. Here, constituent parts that are identical or equivalent to the exposure apparatus 100 of the first embodiment discussed above are assigned identical or similar symbols, and explanations thereof are therefore abbreviated or omitted. In addition, if equivalent members are located at the exposure station 200 and the measurement station 300, then A and B are respectively appended to the symbols of these members to distinguish between them. However, the symbols for the two wafer stages are denoted WST1, WST2.

As can be understood by comparing FIG. 1 with FIG. 15, the exposure station 200 has basically the same configuration as the exposure apparatus 100 of the first embodiment discussed above. In addition, a fine motion stage position measuring system 70B, which is disposed such that it is bilaterally symmetric with a fine motion stage position measuring system 70A on the exposure station 200 side, is disposed in the measurement station 300. In addition, in the measurement station 300, instead of the alignment system ALG an alignment apparatus 99 is attached such that it is suspended from the body BD. A five lens alignment system that is provided with five FIA systems, as disclosed in detail in, for example, PCT International Publication No. WO2008/056735, is used as the alignment apparatus 99.

In addition, in the exposure apparatus 1000, a vertically moveable center table 130 is attached to the base plate 12 at a position between the exposure station 200 and the measurement station 300. The center table 130 comprises a shaft 134, which is capable of moving vertically by a drive apparatus 132 (refer to FIG. 15), and a table main body 136, which is fixed to an upper end of the shaft 134 and has a Y shape in a plan view. In addition, in each bottom surface of coarse motion stages WCS1, WCS2, which constitute the wafer stages WST1, WST2, respectively, a notch is formed that is wider than the shaft 134, includes a separation line between a first portion and a second portion, and is, as a whole, U shaped. Thereby, the wafer stages WST1, WST2 are configured such that either can transport a fine motion stage WFS1 or WFS2 above the table main body 136.

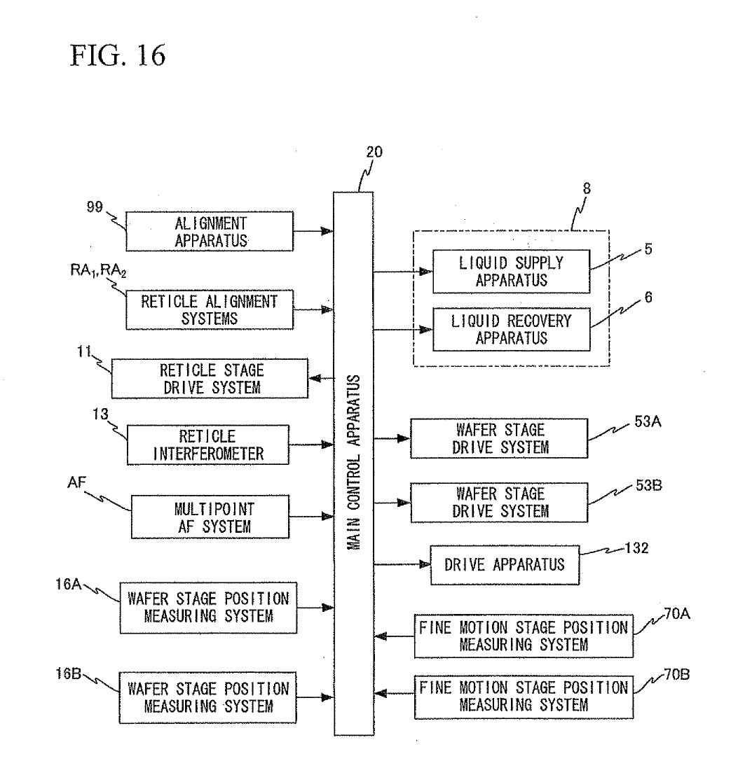

FIG. 16 is a block diagram that shows the principal components of the control system of the exposure apparatus 1000.

In the exposure apparatus 1000 configured as discussed above, an exposure is performed in the exposure station 200 on the wafer W that is disposed on the fine motion stage WFS1 supported by the coarse motion stages WCS1 that constitute the wafer stage WST1, and, in parallel therewith, a wafer alignment (e.g., an EGA) or the like is performed in the measurement station 300 on the wafer W that is disposed on the fine motion stage WFS2 supported by the coarse motion stages WCS2 that constitute the wafer stage WST2.

Furthermore, when the exposure is complete, the wafer stage WST1 transports the fine motion stage WFS1, which holds the exposed wafer W, to above the table main body 136. Furthermore, the center table 130 drives and lifts the drive apparatus 132, the main control apparatus 20 controls a wafer stage drive system 53A, and thereby the coarse motion stages WCS1 are separated into the first portion and the second portion. Thereby, the fine motion stage WFS1 is transferred from the coarse motion stages WCS1 to the table main body 136. Furthermore, after the drive apparatus 132 lowers the center table 130, the coarse motion stages WCS1 return to the state they were in prior to the separation (i.e., to an integrated state). Furthermore, the wafer stage WST2 comes into close proximity or contact with the integrated coarse motion stages WCS1 from the −Y direction, and the fine motion stage WFS2, which holds the aligned wafer W, is transferred from the coarse motion stages WCS2 to the coarse motion stages WCS1. The main control apparatus 20 performs this sequence of operations by controlling a wafer stage drive system 53B.

Subsequently, the coarse motion stages WCS1, which hold the fine motion stage WFS2, move to the exposure station 200 whereupon a reticle alignment is performed; furthermore, a step-and-scan type exposure operation is performed based on the result of that reticle alignment as well as the result of the wafer alignment (i.e., the array coordinates of each of the shot regions on the wafer W wherein the second fiducial mark serves as a reference).

In parallel with this exposure, the coarse motion stages WCS2 withdraw in the −Y direction, a transport system (not shown) transports the fine motion stage WFS1, which is held on the table main body 136, to a prescribed position, and a wafer exchange mechanism (not shown) exchanges the exposed wafer W held by the fine motion stage WFS1 for a new wafer W. Furthermore, the transport system transports the fine motion stage WFS1 that holds the new wafer W onto the table main body 136, after which the fine motion stage WFS1 is transferred from the table main body 136 onto the coarse motion stages WCS2. Subsequently, the same process described above is performed repetitively.

Accordingly, in the modified example shown in FIG. 15, the main control apparatus 20 controls the wafer stage drive system 53A (i.e., the fine motion stage drive system of the wafer stage drive system 53A), which makes it possible both to correct any flexure in the wafer to be exposed at the exposure station 200 as discussed above and to correct any flexure in the fine motion stage discussed above, namely, to correct any flexure in the wafer, by the main control apparatus 20 controlling the wafer stage drive system 53B (i.e., the fine motion stage drive system of the wafer stage drive system 53B) when the wafer alignment is performed at the measurement station 300. In such a case, the position of the alignment mark can be measured with high accuracy and, in turn, based on the alignment results, the wafer can be exposed with higher accuracy.

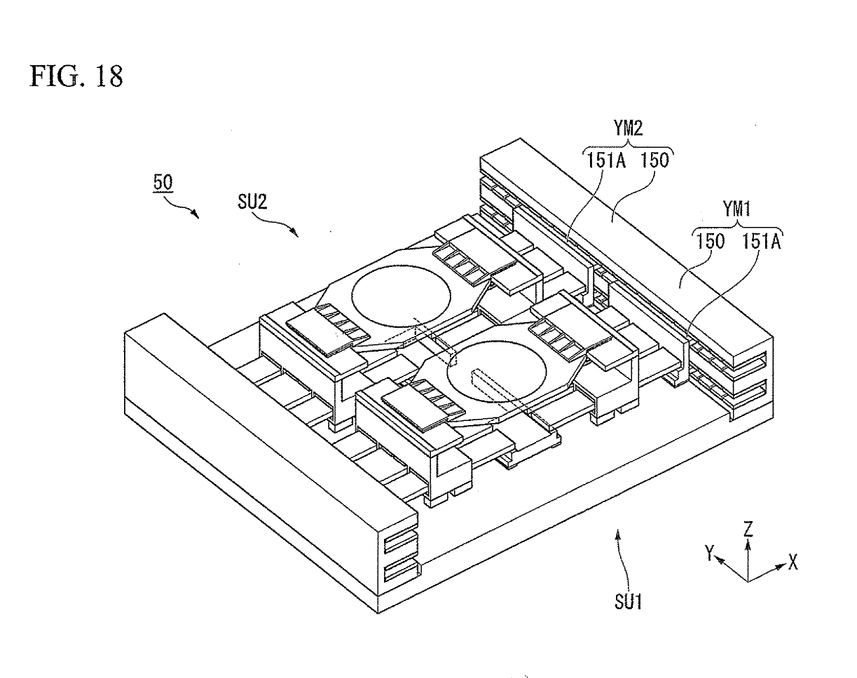

Furthermore, FIG. 18 shows one example of the stage apparatus 50 adapted to a twin wafer stage system.

The modified example in FIG. 18 shows one embodiment of a configuration wherein two Y linear motors, namely, the Y linear motor YM1 and a Y linear motor YM2, share one stator 150, but the present invention is not limited thereto; for example, various configurations can be adopted. In the case wherein the stage apparatus 50 is a twin stage type, two of the fine motion stage position measuring systems 70, corresponding to the two stage units SU1, SU2, may be provided at different positions within the XY plane. Adapting the present invention to a twin stage type exposure apparatus makes it possible to measure, with high accuracy, the positions of the two fine motion stages WFS, which are held by the two stage units SU1, SU2, within the XY plane and, thereby, to drive the fine motion stages WFS1, WFS2 with high accuracy. Furthermore, the twin stage type exposure apparatus can also be a liquid immersion type as discussed above.

Furthermore, the abovementioned embodiment and modified example explained an exemplary case wherein the fine motion stage is supported moveably with respect to the coarse motion stages and a sandwich structure that sandwiches a coil unit between a pair of magnet units is used for the first and second drive parts that drive the fine motion stage in directions corresponding to six degrees of freedom. However, the present invention is not limited thereto; for example, the first and second drive parts may have a structure that vertically sandwiches a magnet unit between a pair of coil units, or they may not have a sandwich structure. In addition, coil units may be disposed in the fine motion stage and magnet units may be disposed in the coarse motion stages.

In addition, in the abovementioned embodiment and modified example, the first and second drive parts drive the fine motion stage in directions corresponding to six degrees of freedom, but the fine motion stage does not necessarily have to be able to be driven in six degrees of freedom. For example, the first and second drive parts do not have to be able to drive the fine motion stage in the θx directions.

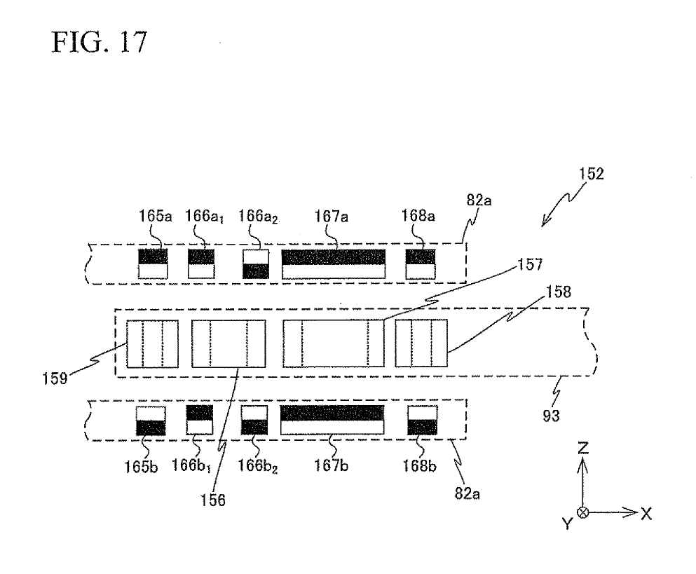

In addition, as the configuration of the first and second drive parts of the fine motion stage drive system that drives the fine motion stage WFS with respect to a coarse motion stage WCS, a configuration such as the first drive part 152 shown in FIG. 17 may be adopted. In the first drive part 152, a first Z drive coil 159, an X drive coil 156, a Y drive coil 157, and a second Z drive coil 158 are disposed inside the stator part 93; furthermore, among these, the Z drive coils 159, 158 and the Y drive coil 157 are disposed in the Y axial directions. In addition, permanent magnets 165a-168a, 165b-168b, which oppose the coils 159-158, are disposed inside plate shaped members 82a1, 82a2 (refer to FIG. 7, FIG. 8A, and FIG. 8B for the arrangement of each of the permanent magnets). The first drive part 152 shown in FIG. 17 can independently control the Z drive coils 159, 158 and the Y drive coil 157, which makes the control simple. In addition, because the fine motion stage WFS can be levitationally supported by constant levitational forces regardless of its position in the Y axial directions, the position of the wafer W in the Z axial directions is stable.

Furthermore, in the abovementioned embodiment, the coarse motion stages WCS support the fine motion stage WFS noncontactually by virtue of the action of the Lorentz's forces (i.e., electromagnetic forces), but the present invention is not limited thereto; for example, a vacuum boosted aerostatic bearing and the like may be provided to the fine motion stage WFS, and the coarse motion stages WCS may levitationally support the fine motion stage WFS. In addition, in the abovementioned embodiment, the fine motion stage WFS can be driven in directions corresponding to a total of six degrees of freedom, but the present invention is not limited thereto; for example, any number of degrees of freedom is acceptable as long as the fine motion stage WFS can move at least within a two dimensional plane that is parallel to the XY plane. In addition, the fine motion stage drive system 52 is not limited to the moving magnet type discussed above and may be a moving coil type. Furthermore, the coarse motion stages WCS may support the fine motion stage WFS contactually. Accordingly, the fine motion stage drive system 52 that drives the fine motion stage WFS with respect to the coarse motion stages WCS may comprise a combination of, for example, a rotary motor and a ball screw (or a feed screw).

In addition, the abovementioned embodiment and modified example explain a case wherein the fine motion stage position measuring system 70 comprises the measuring arm 71, which is formed entirely from, for example, glass, wherethrough light can travel, but the present invention is not limited thereto; for example, the measuring arm may be configured such that at least the portion wherethrough the laser beams discussed above can travel is formed as a solid member capable of transmitting the light, and the remaining portion is a member that, for example, does not transmit the light; furthermore, the measuring arm may have a hollow structure.

In addition, for example, the measuring arm may be configured such that the light source, the photodetector, and the like are built into the tip part of the measuring arm as long as the measurement beams can be radiated from the portion that opposes the grating. In such a case, the measurement beams of the encoder would not have to travel through the interior of the measuring arm. Furthermore, the shape of the measuring arm does not particularly matter. In addition, the fine motion stage position measuring system does not necessarily have to comprise the measuring arm and may have some other configuration as long as it comprises a head disposed such that it opposes the grating RG disposed in the spaces of the coarse motion stages, radiates at least one measurement beam to the grating RG, and receives a diffracted beam of the measurement beam from the grating RG, and as long as the position of the fine motion stage WFS can be measured at least within the XY plane based on the output of that head.

In addition, the abovementioned embodiment explained an exemplary case wherein the encoder system 73 comprises the X head 77x and the pair of Y heads 77ya, 77yb, but the present invention is not limited thereto; for example, one or two two-dimensional heads (i.e., 2D heads), whose measurement directions are in two directions, namely, the X axial directions and the Y axial directions, may be provided. If two 2D heads are provided, then their detection points may be two points that are equidistantly spaced apart from the center of the exposure position on the grating in the X axial directions.

Furthermore, in the abovementioned embodiment, the grating RG is disposed on the upper surface of the fine motion stage WFS, namely, on the surface that opposes the wafer W, but the present invention is not limited thereto; for example, the grating may be formed in the wafer holder, which holds the wafer. In such a case, even if the wafer holder expands during an exposure or if a mounting position deviates with respect to the fine motion stage, it is possible to track this deviation and still measure the position of the wafer holder (i.e., the wafer). In addition, the grating may be disposed on the lower surface of the fine motion stage; in such a case, the measurement beams radiated from the encoder heads would not travel through the interior of the fine motion stage and, therefore, the fine motion stage would not have to be a solid member wherethrough the light can transmit, the interior of the fine motion stage could have a hollow structure wherein piping, wiring, and the like could be disposed, and thereby the fine motion stage could be made more lightweight.

Furthermore, the abovementioned embodiment explained a case wherein the exposure apparatus 100 is a liquid immersion type exposure apparatus, but the present invention is not limited thereto; for example, the present invention can be suitably adapted also to a dry type exposure apparatus that exposes the wafer W without transiting any liquid (i.e., water).

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred to an object with high accuracy. In addition, the present invention can also be adapted to a step-and-stitch type reduction projection exposure apparatus that stitches shot regions together.

In addition, the projection optical system PL in the exposure apparatus 100 of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength laser light in the infrared region or the visible region that is generated from a DFB semiconductor laser or a fiber laser, and then using a nonlinear optical crystal for wavelength conversion to convert the output laser light to ultraviolet light.

In addition, the illumination light IL of the exposure apparatus 100 in the abovementioned embodiment is not limited to light with a wavelength of 100 nm or greater, and, of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle beam, such as an electron beam or an ion beam.

In addition, in the embodiment discussed above an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the above-mentioned embodiment can be obtained by using the encoder system and a laser interferometer system to measure the position of the stage.

In addition, by forming interference fringes on the wafer W as disclosed in, for example, PCT International Publication No. WO2001/035168, the present invention can also be adapted to an exposure apparatus (i.e., a lithographic system) that forms a line-and-space pattern on the wafer W.

Furthermore, the present invention can also be adapted to, for example, an exposure apparatus that combines the patterns of two reticles onto a wafer via a projection optical system and double exposes, substantially simultaneously, a single shot region on the wafer using a single scanning exposure, as disclosed in, for example, U.S. Pat. No. 6,611,316.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus is not limited to an exposure apparatus 100 for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a visible light exposure apparatus, an EUV exposure apparatus, an X-ray exposure apparatus, an electron beam exposure apparatus, and the like.

Furthermore, the moving body apparatus of the present invention is not limited in its application to the exposure apparatus and can be widely adapted to any of the substrate processing apparatuses (e.g., a laser repair apparatus, a substrate inspecting apparatus, and the like) or to an apparatus that comprises a movable stage such as a sample positioning apparatus in a precision machine, or a wire bonding apparatus.

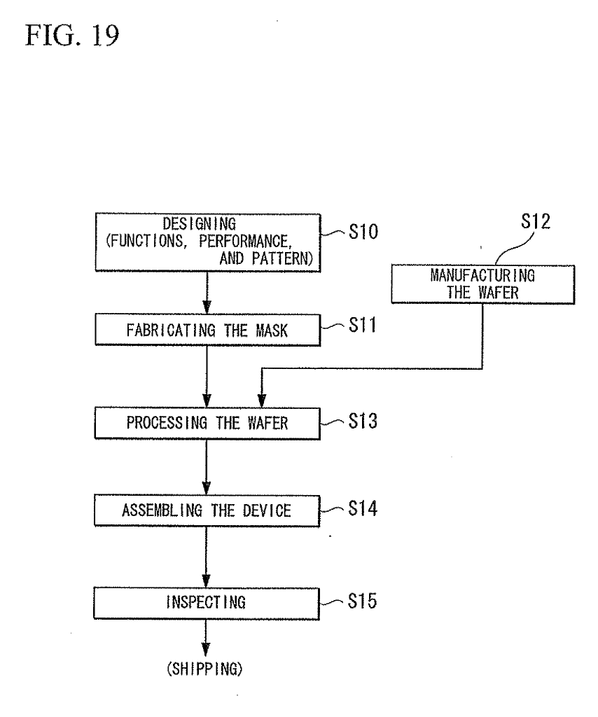

The following text explains a method of fabricating microdevices using the exposure apparatus and the exposing method according to the embodiments of the present invention in a lithographic process. FIG. 19 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

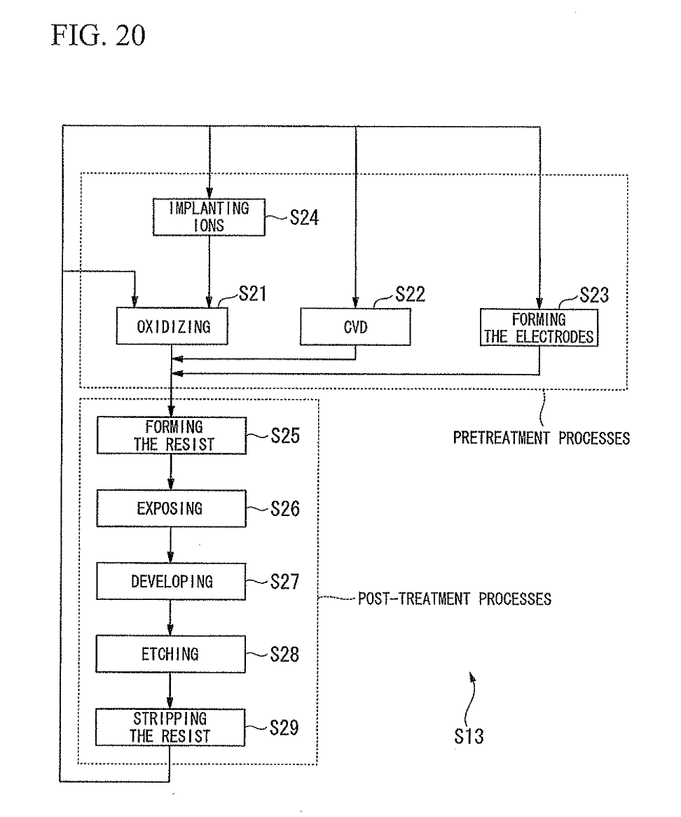

FIG. 20 depicts one example of the detailed process of the step S13 for the case of a semiconductor device.

In a step S21 (i.e., an oxidizing step), the front surface of the wafer is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist removing step), etching is finished and the resist that is no longer needed is stripped. Circuit patterns are superposingly formed on the wafer by repetitively performing the pretreatment and post-treatment processes.

As explained above, a moving body apparatus of embodiments of the present invention is suitable for driving a moving body within a prescribed plane. In addition, an exposure apparatus and an exposing method of embodiments of the present invention are suitable for forming a pattern on an object by radiating an energy beam thereto. In addition, a device fabricating method of embodiments of the present invention is suitable for fabricating electronic devices.

In one embodiment of the present invention, a holding member holds an object; furthermore, the one end part and the other end part of the holding member in first direction are each supported by a moving body such that the holding member is capable of moving relative to the two second moving bodies within a plane parallel to the two dimensional plane. Furthermore, the first and second drive parts exert upon the one end part and the other end part of the holding member in the first directions driving forces (the magnitude and generation direction of which can be controlled independently) in directions parallel to the first directions, directions parallel to the second directions, directions orthogonal to the two dimensional plane, and rotational directions around an axis parallel to the first directions. Accordingly, the first and second drive parts can not only drive the holding member in directions parallel to the first directions, directions parallel to the second directions, and directions orthogonal to the two dimensional plane, but can simultaneously deform the holding member (and the object held thereby) into a concave shape or a convex shape (within a plane perpendicular to the first directions), viewed from directions parallel to the first directions, by causing driving forces in the rotational directions around the axis parallel to the first directions to act in opposite directions on the one end part and the other end part of the holding member. In other words, if the holding member (and the object held thereby) deforms owing to its self weight and the like, that deformation can be corrected.

1. An exposure apparatus that forms a pattern on an object by radiating an energy beam, comprising:
a first moving body, which comprises guide members that extend in a first direction, that moves in a second direction, which is substantially orthogonal to the first direction;
two second moving bodies, which are provided such that they are capable of moving in the first direction along the guide members, that move in the second direction together with the guide members by the movement of the first moving body; and
a holding member, which is detachably supported by the two second moving bodies and is capable of holding the object and moving with respect to the two second moving bodies;
wherein,
the second moving bodies comprise:
a first drive part, which is provided to one of the two second moving bodies, that exerts upon one end part of the holding member a driving force in a direction parallel to the first direction, a direction parallel to the second direction, a direction orthogonal to a two dimensional plane that includes the first direction and the second direction, and a rotational direction around an axis parallel to the first direction; and
a second drive part, which is provided to the other of the two second moving bodies, that exerts upon an other end part of the holding member, which is on a side opposite that of the one end part in the first direction, a driving force in a direction parallel to the first direction, a direction parallel to the second direction, a direction orthogonal to the two dimensional plane that includes the first direction and the second direction, and a rotational direction around an axis parallel to the first direction; and
the first drive part and the second drive part are independently controllable.

2. The exposure apparatus according to claim 1, wherein
the first drive part and the second drive part each control a driving force in direction orthogonal to the two dimensional plane and cooperatively exert upon the holding member a driving force around an axis parallel to the second direction.

3. The exposure apparatus according to claim 1, wherein
each of the first and second drive parts comprises:
a coil unit, which comprises two coil columns disposed in one member selected from the group consisting of the second moving bodies and the holding member and such that they are arrayed in a direction parallel to the second direction; and
a magnet unit, which comprises two magnet columns and are disposed in the other member selected from the group consisting of the second moving bodies and the holding member and such that they are arrayed corresponding to the coil columns in a direction parallel to the second direction; and
electromagnetic interaction between the magnet unit and the coil unit generate an electromagnetic force that noncontactually drive the holding member.

4. An exposure apparatus according to claim 1, further comprising:
a first measuring system, which measures information related to the position of the holding member at least within the two dimensional plane; and
a second measuring system, which radiates at least three second measuring beams to the holding member, receives reflected beams thereof, and measures the positional information, at least three points, of the holding member in a direction orthogonal to the two dimensional plane;
wherein,
based on the outputs of the first and second measuring systems, the first and second drive parts drive the holding member.

5. The exposure apparatus according to claim 4, wherein
at least part of the holding member is a solid part wherethrough light can travel;
a measurement surface is provided to one surface of the holding member that is substantially parallel to the two dimensional plane opposing the solid part of the holding member on the object holding surface side; and
the first measuring system comprises a head part, which is disposed between the two second moving bodies such that it opposes the solid part on the side opposite the object holding surface, that radiates at least one measurement beam to the measurement surface and receives the light of that measurement beam from the measurement surface; and
based on the output of the head part, the first measuring system measures information related to the position of the holding member at least within the two dimensional plane.

6. The exposure apparatus according to claim 5, wherein
a measurement center, which is the center of the irradiation points of the measurement beams radiated from the head part to the measurement surface, coincides with an exposure position, which is the center of an irradiation area of the energy beam radiated to the object.

7. The exposure apparatus according to claim 4, further comprising:
a control apparatus, which controls the drive system based on the output of the second measuring system so as to adjust the flexure of the holding member whereon the object is mounted.

8. The exposure apparatus according to claim 7, wherein
the control apparatus controls the drive system in order to prevent deformation of the object owing to its self weight.

9. The exposure apparatus according to claim 7, further comprising:
an optical system, wherethrough the energy beam radiated to the object transits; and
wherein the control apparatus controls the drive system such that an area that includes the irradiation area of the energy beam on the surface of the object mounted on the holding member falls within the range of the depth of focus of the optical system.

10. The exposure apparatus according to claim 4, wherein
when a scanning exposure, which scans the object relative to the energy beam in a scanning direction within the two dimensional plane, is performed, the drive system scans and drives only the holding member in the scanning direction based on the positional information measured by the first measuring system.

11. A device fabricating method, comprising:
exposing a substrate, which serves as the object, using an exposure apparatus according to claim 1; and
developing the exposed substrate.
